(19) United States
(12) Patent Application Publication
(10) Pub. No.: US 2026/0293971 A1
(43) Pub. Date: Oct. 1, 2026

(54) IMPROVED AEROSOL-GENERATING SUBSTRATE COMPRISING POROUS AEROSOL-GENERATING GRANULES

(71) Applicant: Philip Morris Products S.A., Neuchatel (CH)

(72) Inventor: Rui Nuno Rodrigues Alves BATISTA, Morges (CH)

(73) Assignee: Philip Morris Products S.A., Neuchatel (CH)

(21) Appl. No.: 19/475,628

(22) PCT Filed: Apr. 11, 2024
(86) PCT No.: PCT/EP2024/059910

§ 371 Date: Oct. 15, 2025

(30) Foreign Application Priority Data
Apr. 21, 2023 (EP) 23169317.7

(51) Int. Cl. A24D 1/20; A24B 15/12; A24B 15/167; A24B 15/28; A24D 1/00; A24F 40/10; A24F 40/20; A24F 40/30; H05B 3/03

(52) U.S. Cl. CPC A24D 1/20; A24B 15/12; A24B 15/167; A24B 15/287; A24D 1/002; A24F 40/10; A24F 40/20; A24F 40/30; H05B 3/03

(57) ABSTRACT

An aerosol-generating substrate for a heated aerosol-generating article is provided, the aerosol-generating substrate including: a rod of a first aerosol-generating material, the first aerosol-generating material including tobacco cut filler, or the first aerosol-generating material including one or more sheets or strands of homogenised plant material; and a plurality of aerosol-generating granules dispersed through the rod of the first aerosol-generating material, the plurality of aerosol-generating granules including a porous carrier medium defining a plurality of pores and a second aerosol-generating material releasably retained within the pores of the porous carrier medium, the second aerosol-generating material being in the form of a liquid or a gel and comprising a flavourant and an aerosol former.

The present invention relates to an improved aerosol-generating substrate for use in a heated aerosol-generating article.

Aerosol-generating articles in which a solid aerosol-generating substrate is heated rather than combusted are known in the art. Typically such articles use tobacco-containing aerosol-generating substrates, usually in crimped, shredded, or cut-filler forms inside a rod. Consumables with other solid substrates, such as those with gels and films containing nicotine, are also known in the art. In heat-not-burn (HNB) articles, an aerosol is typically generated by the transfer of heat from a heat source to a physically separate aerosol-generating substrate, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

A number of prior art documents disclose aerosol-generating devices for consuming aerosol-generating articles. Such devices include, for example, electrically heated aerosol-generating devices in which an aerosol is generated by the transfer of heat from one or more electrical heater elements of the aerosol-generating device to the aerosol-generating substrate of a heated aerosol-generating article. For example, electrically heated aerosol-generating devices have been proposed that comprise an internal heater blade which is adapted to be inserted into the aerosol-generating substrate. As an alternative, inductively heatable aerosol-generating articles comprising an aerosol-generating substrate and a susceptor arranged within the aerosol-generating substrate have been proposed by WO 2015/176898. A further alternative has been described in WO 2020/115151, which discloses an aerosol-generating article used in combination with an external heating system comprising one or more heating elements arranged around the periphery of the aerosol-generating article.

Solid aerosol-generating substrates may comprise plant material, such as tobacco material, and an aerosol former. Solid aerosol-generating substrates in the form of gels or films may comprise nicotine, an aerosol former and polysaccharide materials, such as cellulose-based agents or gelling agents. Liquid or gel flavourants may also be included in solid aerosol-generating substrates. For example, it is known to add liquid or gel flavourants to enhance the sensorial qualities of aerosol generated by tobacco-containing aerosol-generating substrates, such as crimped tobacco cast-leaf.

However, liquid or gel flavourants in a solid aerosol-generating substrate may evaporate, migrate or sublimate over time. Evaporation or sublimation of flavourants may be exacerbated by high environmental temperatures and humidities. Migration of flavourants within the solid aerosol-generating substrate may cause uneven distribution of flavourant within the solid aerosol-generating substrate or leakage of the flavourant from the solid aerosol-generating substrate. Loss of flavourants during storage through evaporation, migration, or sublimation may negatively impact the overall performance of the substrate. This may disadvantageously reduce the shelf-life of the substrate. For example, evaporation, migration, and sublimation over time of one or more flavourants in a substrate may negatively impact the perceived taste of the inhalable aerosol generated by a substrate containing the liquid or gel flavourants.

Moreover, liquid or gel flavourants may interact chemically with the other components of the solid aerosol-generating substrate. Undesirably, this chemical interaction may lead to progressive chemical degradation over time of both the flavourants and the aerosol-generating substrate. As a result, articles containing such aerosol-generating substrates may have a reduced shelf-life. In addition, progressive chemical degradation of the aerosol-generating substrate may negatively impact the overall performance of the article. For example, chemical degradation of flavourants in the article may negatively affect the flavour of the aerosol generated as perceived by the consumer.

Liquid or gel flavourants may be prone to leakage from solid aerosol-generating substrates during storage, handling and use thereof. Leakage of liquid or gel flavourants may be exacerbated by high environmental temperatures and humidities, or by external physical forces such as pressure, centrifugal forces, shaking motions, or impact forces from being dropped. Leakage of the flavourant from the solid aerosol-generating substrate may result in chemical interaction between the flavourant and surrounding components of an aerosol-generating device. Such chemical interaction may lead to chemical degradation of both the flavourant and the components of the device, which may negatively impact both the flavour perceived by the consumer and the performance of the device. Leakage of liquid or gel flavourants from the solid aerosol-generating substrate may thus disadvantageously reduce the lifespan of the aerosol-generating device in which the substrate is heated.

Typically, in conventional aerosol-generating systems containing articles with solid aerosol-generating substrates, there may be a short delay following the actuation of the heater until the solid substrate is heated sufficiently to generate an aerosol. Moreover, when the solid aerosol-generating substrate becomes depleted at the end of the user experience, the aerosol content may differ from the aerosol content experienced by the user earlier in the experience and prior to the depletion of the substrate. Therefore, in conventional aerosol-generating systems the content of aerosol generated may not be consistent over time, and the content of aerosol delivered to the user may vary over time across the user experience.

It would be desirable to provide a solid aerosol-generating substrate comprising one or more liquid or gel flavourants in which evaporation, migration, or sublimation over time of one or more liquid or gel flavourants is prevented or reduced compared to known substrates.

It would be desirable to provide an aerosol-generating substrate including a flavourant to enhance the sensorial qualities of the substrate, while at the same time avoiding chemical degradation of both the flavourant and the substrate.

It would be desirable to provide a solid aerosol-generating substrate in which leakage of flavourant during storage, handling and use of the substrate is prevented or reduced compared to known substrates.

It would be desirable to provide a substrate having a more consistent delivery of aerosol over time during use. It would be desirable to provide a substrate having an improved duration of aerosol generation during use. It would be desirable to provide a substrate in which the aerosol generated may be controlled to provide a more consistent user experience. It would be desirable to provide a substrate including a flavourant that may be manufactured using existing production equipment and at low cost.

Therefore, it would be desirable to provide a new and improved aerosol-generating substrate adapted to satisfy at least one of the needs above.

The present disclosure relates to an aerosol-generating substrate for use in a heated aerosol-generating article. The aerosol-generating substrate may comprise a rod of a first aerosol-generating material. The first aerosol-generating material may comprise tobacco cut filler or one or more sheets or strands of homogenised plant material. The aerosol-generating substrate may further comprise a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium. The second aerosol-generating material may be in the form of a liquid or a gel. The second aerosol-generating material may comprise a flavourant and an aerosol former.

The present disclosure relates to an aerosol-generating article comprising an aerosol generating substrate. The aerosol-generating substrate may comprise a rod of a first aerosol-generating material. The first aerosol-generating material may comprise tobacco cut filler or one or more sheets or strands of homogenised plant material. The aerosol-generating substrate may further comprise a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium. The second aerosol-generating material may be in the form of a liquid or a gel. The second aerosol-generating material may comprise a flavourant and an aerosol former.

The present disclosure relates to an aerosol-generating system comprising an aerosol-generating article, and an electrical aerosol generating device for heating the aerosol-generating substrate of the aerosol-generating article. The aerosol-generating article may comprise an aerosol-generating substrate. The aerosol-generating substrate may comprise a rod of a first aerosol-generating material. The first aerosol-generating material may comprise tobacco cut filler or one or more sheets or strands of homogenised plant material. The aerosol-generating substrate may further comprise a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium. The second aerosol-generating material may be in the form of a liquid or a gel. The second aerosol-generating material may comprise a flavourant and an aerosol former.

According to the first aspect of the present invention there is provided an aerosol-generating substrate for use in a heated aerosol-generating article. The aerosol-generating substrate comprises a rod of a first aerosol-generating material. The first aerosol-generating material comprises tobacco cut filler or one or more sheets or strands of homogenised plant material. The aerosol-generating substrate further comprises a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium. The second aerosol-generating material is in the form of a liquid or a gel. The second aerosol-generating material comprises a flavourant and an aerosol former.

According to the second aspect of the present invention there is provided an aerosol-generating article comprising an aerosol-generating substrate. The aerosol-generating substrate comprises a rod of a first aerosol-generating material. The first aerosol-generating material comprises tobacco cut filler or one or more sheets or strands of homogenised plant material. The aerosol-generating substrate further comprises a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium. The second aerosol-generating material is in the form of a liquid or a gel. The second aerosol-generating material comprises a flavourant and an aerosol former.

According to the third aspect of the present invention there is provided an aerosol-generating system comprising an aerosol-generating article, and an electrical aerosol generating device for heating the aerosol-generating substrate of the aerosol-generating article. The aerosol-generating article comprises an aerosol-generating substrate. The aerosol-generating substrate comprises a rod of a first aerosol-generating material. The first aerosol-generating material comprises tobacco cut filler or one or more sheets or strands of homogenised plant material. The aerosol-generating substrate further comprises a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium. The second aerosol-generating material is in the form of a liquid or a gel. The second aerosol-generating material comprises a flavourant and an aerosol former.

The substrate of the invention comprises a plurality of aerosol-generating granules dispersed through the rod of the first aerosol-generating material, wherein a second aerosol-generating material is releasably retained within the pores of a porous carrier medium. Prior to use of the substrate by heating, the second-aerosol generating material is retained and immobilised within the pores until it is heated in such a way that it is volatilised and free to leave the pores of the porous carrier medium in the form of an aerosol.

Providing a second aerosol-generating material releasably retained within the plurality of pores of the plurality of aerosol-generating granules may advantageously reduce or prevent evaporation, migration or sublimation over time of the flavourant in the second aerosol-generating material. This may advantageously increase the shelf-life of the substrate according to the first aspect of the invention compared to known substrates.

Preventing or reducing evaporation, migration or sublimation over time of the flavourant in the second aerosol-generating material over time may advantageously improve the perceived quality and consistency of the inhalable aerosol generated by substrates according to the first aspect of the invention compared to known substrates. For example, preventing or reducing evaporation, migration or sublimation of the flavourant in the second aerosol-generating material may advantageously improve the perceived taste of the inhalable aerosol generated by substrates according to the first aspect of the invention compared to known substrates.

Providing a second aerosol-generating material releasably retained within the plurality of pores of the plurality of aerosol-generating granules may prevent or reduce evaporation or sublimation of the second aerosol-generating material prior to use of the substrate. The second aerosol-generating material comprises volatile components such as flavourant and aerosol-former. When volatile components are adsorbed on the vesicular surfaces of the pores of the porous carrier medium, the volatile components are subject to adsorption forces with the vesicular surfaces. The volatile components are thus held more strongly and their loss through evaporation or sublimation is prevented. An uneven flavour profile due to loss of volatile components within the second aerosol-generating material may therefore be prevented. This may improve the consistency of the aerosol generated during use of articles containing the substrate.

Because the second aerosol-generating material comprises a flavourant releasably retained within the aerosol-generating granules dispersed through the rod of first aerosol-generating material, if the aerosol-generating granules are substantially uniformly distributed through the rod, an uneven flavour profile due to migration of the flavourant may be prevented. This may improve the consistency of the aerosol generated during use of articles containing the substrate. Furthermore, depending on the distribution of the aerosol-generating granules within the rod, the flavour profile of the substrate may advantageously be tuned.

Moreover, preventing or reducing migration of the second aerosol-generating material within the first aerosol-generating material prior to use of the substrate may prevent or reduce chemical reaction between the second aerosol-generating material and the first aerosol-generating material during storage. Finally, preventing or reducing migration of the second aerosol-generating material within the first aerosol-generating material prior to use of the substrate may prevent or reduce leakage of the second aerosol-generating material from the first aerosol-generating material prior to use of the substrate.

Providing a plurality of aerosol-generating granules comprising a second aerosol-generating material releasably retained within the pores of a porous carrier medium may advantageously reduce or prevent leakage of the second aerosol-generating material during storage, handling and use of substrates according to the first aspect of the invention. This may increase the shelf-life of substrates according to the invention compared to known substrates.

Reducing or preventing leakage of the second aerosol-generating material during storage, handling and use may advantageously improve the consistency of the inhalable aerosol generated by substrates according to the first aspect of the invention compared to known substrates. Reducing or preventing leakage of the second aerosol-generating material during storage, handling and use of substrates according to the first aspect of the invention may advantageously reduce or prevent chemical interaction with and damage to other components of aerosol-generating systems according to the third aspect of the invention.

Providing a second aerosol-generating material releasably retained within the plurality of pores of the plurality of aerosol-generating granules may prevent or reduce direct contact between the second aerosol-generating material and the first aerosol-generating material prior to use of the substrate. This may prevent or reduce chemical reaction between the second aerosol-generating material and the first aerosol-generating material during storage. Advantageously, preventing or reducing progressive chemical degradation of the first and second aerosol-generating materials may lead to an increased shelf-life for the substrates of the present invention relative to existing substrates. Advantageously, preventing or reducing progressive chemical degradation of the first and second aerosol-generating materials may improve the quality of the aerosol generated as perceived by the consumer during use of articles containing the substrate. Advantageously, preventing or reducing progressive chemical degradation of the first and second aerosol-generating materials may improve the consistency of the aerosol generated during use of articles containing the substrate.

As a result of differing properties between the first aerosol-generating material in the rod and the second aerosol-generating material releasably retained within the pores of the porous carrier material of the plurality of aerosol-generating granules, the first-aerosol generating material and the second aerosol-generating material will exhibit a different aerosol release profile or puff profile, which corresponds to the amount of aerosol released from the material during each puff, over the duration of consumption.

Advantageously, releasably retaining the second aerosol-generating material within the pores of the porous carrier medium on a plurality of aerosol-generating granules dispersed within the rod of first aerosol-generating material allows for generation of a more consistent aerosol content over time, leading to a more consistent user experience.

For example, the second aerosol-generating material may have a lower aerosolization temperature than the first aerosol-generating material, wherein the aerosolization temperature corresponds to the lowest temperature at which a measurable amount of aerosol is released from the material. A lower aerosolization temperature therefore provides a shorter time to first puff for the consumer and the second aerosol-generating material will release a higher level of aerosol than the first aerosol-generating material during the earlier puffs in the puff profile. Because in conventional aerosol-generating systems there may be a short delay following the actuation of the heater until the first aerosol-generating material is heated sufficiently to generate an aerosol, provision of the second aerosol-generating material with a lower aerosolization temperature shortens the time until an aerosol is generated, thus resulting in a shorter delay until aerosol is delivered to the consumer. This reduces or eliminates the problem of “cold puffs.”

Alternatively, the second aerosol-generating material may have a higher aerosolization temperature than the first aerosol-generating material. With a higher aerosolization temperature, the second aerosol-generating material will take a longer time after heating to begin to release the aerosol but may continue to release aerosol after the release of aerosol from the first aerosol-generating material has finished. The second aerosol-generating material will therefore release a higher level of aerosol than the first aerosol-generating material during later puffs in the puff profile. This allows for continued release of aerosol from the second aerosol-generating material once the first aerosol-generating material has been depleted, and lengthens the user experience.

In combination, the first aerosol-generating material and the second aerosol-generating material of the substrate are therefore able to provide a highly consistent delivery of aerosol over time, during consumption of an aerosol-generating article.

Advantageously, substrates according to the invention can be manufactured using existing production equipment and at a low cost.

As used herein, the term “aerosol-generating substrate” is used to describe a substrate comprising aerosol-generating material that is capable of releasing upon heating volatile compounds that can generate an aerosol.

As used herein, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosolization temperature” is used to describe the lowest temperature at which a measurable amount of aerosol is released from an aerosol-generating substrate.

As used herein, the term “aerosol-generating device” denotes a device that interacts with an aerosol-generating substrate to generate an aerosol. In particular, the aerosol-generating device may heat the aerosol-generating substrate comprising the rod of first aerosol-generating material and the second aerosol-generating material releasably retained within the pores of the porous carrier medium of the aerosol-generating granules to facilitate release of volatile compounds from the respective aerosol-generating materials.

As used herein, the term “gel” is used to describe a substantially dilute cross-linked material, which exhibits no flow in the steady state.

As used herein, the terms “proximal”, “distal”, “upstream” and “downstream” describe the relative positions of elements, or portions of elements, of an aerosol-generating article in relation to the direction in which the aerosol is transported through the aerosol-generating article during use.

An aerosol-generating article comprises a proximal end through which, in use, an aerosol exits the aerosol-generating article. The proximal end of the aerosol-generating article may also be referred to as the downstream end. The distal end of the aerosol-generating article may also be referred to as the upstream end. Components, or portions of components, of the aerosol-generating article may be described as being upstream or downstream of one another based on their relative positions between the proximal or downstream end and the distal or upstream end of the aerosol-generating article.

As used herein, the term “longitudinal” refers to a direction extending from an upstream end to a downstream end of the substrate, or to a direction extending from an upstream end to a downstream end of an article or system of which the substrate is part. As used herein, the term “transverse” may refer to a direction perpendicular to the longitudinal direction.

As used herein, the term “length” is used to describe the maximum longitudinal dimension of components, or portions of components, of the aerosol-generating substrate, article or system parallel to the longitudinal axis between the proximal end and the opposed distal end of the aerosol-generating substrate, article or system.

As used herein, the terms “height” and “width” are used to describe the maximum transverse dimensions of components, or portions of components, of the aerosol-generating substrate, article or system perpendicular to the longitudinal axis of the aerosol-generating substrate, article or system. Where the height and width of components, or portions of components, of the substrate, article or system are not the same, the term “width” is used to refer to the larger of the two transverse dimensions perpendicular to the longitudinal axis of the substrate, article or system.

Unless otherwise stated, properties of aerosol-generating substrates recited herein are those prior to use of the substrate.

Unless otherwise stated, percentages by weight of components of an aerosol-generating substrate recited herein are based on the total weight of the aerosol-generating substrate.

Unless otherwise stated, as used herein, the term “cross-section” refers to the transverse cross-section.

The aerosol-generating substrate comprises a rod of a first aerosol-generating material. The aerosol-generating substrate may be a rod of aerosol-generating substrate.

The rod may have a longitudinal direction and a transverse, or radial, direction perpendicular to the longitudinal direction. The rod may be cylindrical in shape. The rod may have a length extending in the longitudinal direction and a radius extending in the transverse, or radial, direction.

As used herein, the term “rod” is used to denote a generally cylindrical element of substantially circular, oval or elliptical cross-section.

The first aerosol-generating material may be any suitable solid aerosol-generating material capable of being formed into a rod. The first aerosol-generating material may comprise tobacco cut filler. The first aerosol-generating material may comprise homogenised plant material. The first aerosol-generating material may comprise a gel composition, preferably a gel composition containing nicotine. The first aerosol-generating material may comprise an aerosol-generating film, preferably an aerosol-generating film containing nicotine. Preferably, the first aerosol-generating material comprises tobacco cut filler or homogenised plant material.

The first aerosol-generating material may comprise, or be in the form of, one or more of: cut-filler, powder particles, grains, pellets, shreds, spaghettis, strips, sheets, or gel.

The first aerosol-generating material may comprise one or more aerosol-formers. As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-generating substrate or aerosol-generating article.

Suitable aerosol formers are well known in the art and include, but are not limited to, one or more aerosol formers selected from: polyhydric alcohols, such as propylene glycol, polyethylene glycol, triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol former to be or comprise glycerine.

The first aerosol-generating material may comprise at least 1, 2, 5, 10, 12, 15, 40, 45, 50, 52, 60 or 70 weight percent aerosol former. The first aerosol-generating material may comprise at most 80, 75, 60, 54, 30, 25 or 20 weight percent aerosol former. For example, when the first aerosol-generating material is tobacco cut filler, the first aerosol-generating material may comprise between 12 and 25 weight percent aerosol former. For example, when the first aerosol-generating material is homogenised plant material, the first aerosol-generating material may comprise between 15 and 20 weight percent aerosol former. For example, when the first aerosol-generating material is a gel composition, the first aerosol-generating material may comprise between 70 and 75 weight percent aerosol former. For example, when the first aerosol-generating material is an aerosol-generating film, the first aerosol-generating material may comprise between 40 and 60 weight percent aerosol former.

The aerosol former may be glycerine. The first aerosol-generating material may comprise at least 1, 2, 5, 10, 12, 15, 40, 45, 50, 52, 60 or 70 weight percent glycerine. The first aerosol-generating material may comprise at most 80, 75, 60, 54, 30, 25 or 20 weight percent glycerine. For example, when the first aerosol-generating material is tobacco cut filler, the first aerosol-generating material may comprise between 12 and 25 weight percent aerosol former. For example, when the first aerosol-generating material is homogenised plant material, the first aerosol-generating material may comprise between 15 and 20 weight percent glycerine. For example, when the first aerosol-generating material is a gel composition, the first aerosol-generating material may comprise between 70 and 75 weight percent glycerine. For example, when the first aerosol-generating material is an aerosol-generating film, the first aerosol-generating material may comprise between 40 and 60 weight percent glycerine.

The first aerosol-generating material may comprise one or more organic materials such as tobacco. The first aerosol-generating material may comprise one or more of herb leaf, tobacco leaf, fragments of tobacco ribs, reconstituted tobacco, homogenised tobacco, extruded tobacco and expanded tobacco.

The first aerosol-generating material may comprise tobacco particles. The tobacco particles may have a particle size distribution having a D10 tobacco particle size, a D50 tobacco particle size and a D90 tobacco particle size.

The D10 tobacco particle size may be between 1 and 20, or 1 and 10 microns. The D 10 tobacco particle size may be around 3 microns.

The D90 tobacco particle size may be between 40 and 200 or 40 and 100 microns. The D90 tobacco particle size may be around 70 microns.

The first aerosol-generating material may comprise nicotine.

The first aerosol-generating material may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The first aerosol-generating material may comprise, or may be in the form of, tobacco cut-filler. The cut width of the cut-filler may be between 0.3 and 2, 0.5 and 1.2, or 0.6 and 0.9 millimetres.

The cut width may affect the distribution of heat in the first aerosol-generating material, the resistance to draw of the first aerosol-generating material, and the overall density of the first aerosol-generating material. The inventors have found that the above cut width ranges may be desirable in terms of heat distribution, resistance to draw, and density.

In certain preferred embodiments, the first aerosol-generating material comprises homogenised plant material, preferably a homogenised tobacco material.

As used herein, the term “homogenised plant material” encompasses any plant material formed by the agglomeration of particles of plant. For example, sheets or webs of homogenised tobacco material may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art.

The first aerosol-generating material may comprise homogenised plant material in any suitable form. For example, the homogenised plant material may be in the form of one or more sheets or strands.

Alternatively or in addition, the homogenised plant material may be in the form of a plurality of pellets or grains.

As used herein, the term “sheet” describes a generally planar, laminar element having a width and length substantially greater than the thickness thereof.

As used herein, the term “strand” describes an elongate element of material having a length that is substantially greater than the width and thickness thereof. The term “strand” should be considered to encompass strips, shreds and any other homogenised plant material having a similar form. The strands of homogenised plant material may be formed from a sheet of homogenised plant material, for example by cutting or shredding, or by other methods, for example, by an extrusion method.

Each of the plurality of strands may extend in a substantially longitudinal direction of the first aerosol-generating material or aerosol-generating article. Each of the plurality of strands may have a length of at least about 3, 5 or 10 millimetres. Each of the plurality of strands may have a width of less than about 3, 2 or 1 millimetres.

The first aerosol-generating material may comprise, or may be in the form of, one or more sheets, for example one or more gathered sheets. The or each sheet, for example gathered sheet, may have a width of at least about 10, 25, 50, or 100 millimetres. The or each sheet, for example gathered sheet, may have a length of at least about 3, 5 or 10 millimetres. The or each sheet, for example gathered sheet, may have a thickness of at least about 100, 150 or 200 microns. The or each sheet, for example gathered sheet, may have a thickness of less than about 500, 400 or 300 microns. The or each sheet, for example gathered sheet, may have a thickness between 100 and 500, 170 and 400, or 200 and 300 microns. The or each sheet, for example gathered sheet, may have a thickness of around 235 microns.

As used herein, the term “gathered sheet” may refer to a sheet of an aerosol-generating material, aerosol-generating substrate or aerosol-generating article that is convoluted, folded, or otherwise compressed or constricted substantially transversely to a longitudinal axis of the aerosol-generating material, aerosol-generating substrate, or aerosol-generating article, or otherwise compressed or constricted substantially transversely to the cylindrical axis of a plug or a rod.

The one or more sheets as described herein may each individually have a grammage of between about 100 g/m² and about 300 g/m².

The one or more sheets as described herein may each individually have a density of from about 0.3 g/cm³ to about 1.3 g/cm³ , and preferably from about 0.7 g/cm³ to about 1.0 g/cm³ .

In various embodiments, the one or more sheets of homogenised plant material may be produced by a casting process. In various embodiments, the one or more sheets of homogenised plant material may be produced by a paper-making process.

The one or more sheets of homogenised plant material may advantageously be crimped or similarly treated. As used herein, the term “crimped” denotes a sheet having a plurality of substantially parallel ridges or corrugations. Alternatively or in addition to being crimped, the one or more sheets of homogenised plant material may be embossed, debossed, perforated or otherwise deformed to provide texture on one or both sides of the sheet.

Preferably, each sheet of homogenised plant material may be crimped such that it has a plurality of ridges or corrugations substantially parallel to the cylindrical axis of the rod. This treatment advantageously facilitates gathering of the crimped sheet of homogenised plant material to form the rod. Preferably, the one or more sheets of homogenised plant material may be gathered.

The homogenised plant material may comprise up to about 95 percent by weight of plant particles, on a dry weight basis. Preferably, the homogenised plant material comprises up to about 90 percent by weight of plant particles, more preferably up to about 80 percent by weight of plant particles, more preferably up to about 70 percent by weight of plant particles, more preferably up to about 60 percent by weight of plant particles, more preferably up to about 50 percent by weight of plant particles, on a dry weight basis.

For example, the homogenised plant material may comprise between about 2.5 percent and about 95 percent by weight of plant particles, or about 5 percent and about 90 percent by weight of plant particles, or between about 10 percent and about 80 percent by weight of plant particles, or between about 15 percent and about 70 percent by weight of plant particles, or between about 20 percent and about 60 percent by weight of plant particles, or between about 30 percent and about 50 percent by weight of plant particles, on a dry weight basis.

The homogenised plant material may be a homogenised tobacco material comprising tobacco particles. Sheets of homogenised tobacco material for use in such embodiments of the invention may have a tobacco content of at least about 40 percent by weight on a dry weight basis, more preferably of at least about 50 percent by weight on a dry weight basis, more preferably at least about 70 percent by weight on a dry weight basis and most preferably at least about 90 percent by weight on a dry weight basis.

The term “tobacco particles” describes particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of the invention and are not included in the percentage of particulate plant material.

The tobacco particles may have a nicotine content of at least about 2.5 percent by weight, based on dry weight. More preferably, the tobacco particles may have a nicotine content of at least about 3 percent, even more preferably at least about 3.2 percent, even more preferably at least about 3.5 percent, most preferably at least about 4 percent by weight, based on dry weight.

The homogenised plant material preferably comprises no more than 95 percent by weight of particulate plant material, on a dry weight basis. The particulate plant material is therefore typically combined with one or more other components to form the homogenised plant material.

The homogenised plant material may further comprise a binder to alter the mechanical properties of the particulate plant material, wherein the binder is included in the homogenised plant material during manufacturing as described herein. Suitable exogenous binders would be known to the skilled person and include but are not limited to: gums such as, for example, guar gum, xanthan gum, arabic gum and locust bean gum; cellulosic binders such as, for example, hydroxypropyl cellulose, carboxymethyl cellulose, hydroxyethyl cellulose, methyl cellulose and ethyl cellulose; polysaccharides such as, for example, starches, organic acids, such as alginic acid, conjugate base salts of organic acids, such as sodium-alginate, agar and pectins; and combinations thereof. Preferably, the binder comprises guar gum.

The binder may be present in an amount of from about 1 percent to about 10 percent by weight, based on the dry weight of the homogenised plant material, preferably in an amount of from about 2 percent to about 5 percent by weight, based on the dry weight of the homogenised plant material.

Alternatively or in addition, the homogenised plant material may further comprise one or more lipids to facilitate the diffusivity of volatile components (for example, aerosol formers, gingerols and nicotine), wherein the lipid is included in the homogenised plant material during manufacturing as described herein. Suitable lipids for inclusion in the homogenised plant material include, but are not limited to: medium-chain triglycerides, cocoa butter, palm oil, palm kernel oil, mango oil, shea butter, soybean oil, cottonseed oil, coconut oil, hydrogenated coconut oil, candellila wax, carnauba wax, shellac, sunflower wax, sunflower oil, rice bran, and Revel A; and combinations thereof.

Alternatively or in addition, the homogenised plant material may further comprise a pH modifier.

Alternatively or in addition, the homogenised plant material may further comprise fibres to alter the mechanical properties of the homogenised plant material, wherein the fibres are included in the homogenised plant material during manufacturing as described herein. Suitable exogenous fibres for inclusion in the homogenised plant material are known in the art and include fibres formed from non-tobacco material, including but not limited to: cellulose fibres; soft-wood fibres; hard-wood fibres; jute fibres and combinations thereof. Exogenous fibres derived from tobacco and/or ginger can also be added. Any fibres added to the homogenised plant material are not considered to form part of the “particulate plant material” as defined above. Prior to inclusion in the homogenised plant material, fibres may be treated by suitable processes known in the art including, but not limited to: mechanical pulping; refining; chemical pulping; bleaching; sulfate pulping; and combinations thereof. A fibre typically has a length greater than its width.

Suitable fibres typically have lengths of greater than 400 micrometres and less than or equal to 4 millimetres, preferably within the range of 0.7 millimetres to 4 millimetres. Preferably, the fibres are present in an amount of about 2 percent to about 15 percent by weight, most preferably at about 4 percent by weight, based on the dry weight of the first aerosol-generating material.

The homogenised plant material may further comprise one or more aerosol formers. Preferably the aerosol former is glycerine.

When the first aerosol-generating material is homogenised plant material, the first aerosol-generating material may comprise between 5 and 30 weight percent aerosol former on a dry weight basis, such as between 10 and 25 weight percent aerosol former on a dry weight basis, or between 15 and 20 weight percent aerosol former on a dry weight basis. When the first aerosol-generating material is homogenised plant material, the first aerosol-generating material may comprise between 5 and 30 weight percent glycerine on a dry weight basis, such as between 10 and 25 weight percent glycerine on a dry weight basis, or between 15 and 20 weight percent glycerine on a dry weight basis.

As used herein, the term “additional cellulose” encompasses any cellulosic material incorporated into the homogenised plant material which does not derive from the non-tobacco plant particles or tobacco particles provided in the homogenised plant material. The additional cellulose is therefore incorporated in the homogenised plant material in addition to the non-tobacco plant material or tobacco material, as a separate and distinct source of cellulose to any cellulose intrinsically provided within the non-tobacco plant particles or tobacco particles. The additional cellulose will typically derive from a different plant to the non-tobacco plant particles or tobacco particles. Preferably, the additional cellulose is in the form of an inert cellulosic material, which is sensorially inert and therefore does not substantially impact the organoleptic characteristics of the aerosol generated. For example, the additional cellulose is preferably a tasteless and odourless material.

The additional cellulose may comprise cellulose powder, cellulose fibres, or a combination thereof.

The aerosol former may act as a humectant.

In some embodiments, the first aerosol-generating material may comprise a gel composition, preferably a gel composition containing nicotine.

Preferably, the gel composition comprises nicotine, an aerosol former, and at least one gelling agent. Preferably, the aerosol former is glycerine.

In some embodiments, the first aerosol-generating material may comprise an aerosol-generating film, preferably an aerosol-generating film containing nicotine.

Preferably the film comprises nicotine, a cellulose-based agent, an aerosol former, and optionally, a carboxylic acid. Preferably, the aerosol former is glycerine. Such a film may be substantially tobacco-free.

An elongate susceptor element may be arranged substantially longitudinally within the rod of first aerosol-generating material within the aerosol-generating substrate and in thermal contact with the first aerosol-generating material and aerosol-generating substrate.

As used herein, the term “susceptor element” refers to a material that can convert electromagnetic energy into heat. When located within a fluctuating electromagnetic field, eddy currents induced in the susceptor element cause heating of the susceptor element. As the elongate susceptor element is located in thermal contact with the aerosol-generating substrate, the aerosol-generating substrate is heated by the susceptor element.

When used for describing the susceptor element, the term “elongate” means that the susceptor element has a length dimension that is greater than its width dimension or its thickness dimension, for example greater than twice its width dimension or its thickness dimension.

The elongate susceptor element may be positioned in a radially central position within the rod, and extend along the longitudinal axis of the rod.

Preferably the susceptor element has substantially the same length as the rod of first aerosol-generating material within the aerosol-generating substrate, and extends from the upstream end of the rod to the downstream end of the rod.

The susceptor element is preferably in the form of a pin, rod, strip or blade.

The susceptor element may be formed from any material that can be inductively heated to a temperature sufficient to generate an aerosol from the solid aerosol-generating substrate.

Preferably, the susceptor comprises a metal, an alloy or carbon.

The wrapper circumscribing the rod of first aerosol-generating material or the aerosol-generating substrate may be a paper wrapper or a non-paper wrapper. When the first aerosol-generating material comprises one or more sheets of homogenised plant material, the one or more sheets of homogenised plant material may be gathered transversely relative to the longitudinal axis thereof and circumscribed with a wrapper to form the rod of first-aerosol generating material. Suitable paper wrappers for use in specific embodiments of the invention are known in the art and include, but are not limited to: cigarette papers; and filter plug wraps. Suitable non-paper wrappers for use in specific embodiments of the invention are known in the art and include, but are not limited to sheets of homogenised tobacco materials. In certain preferred embodiments, the wrapper may be formed of a laminate material comprising a plurality of layers. Preferably, the wrapper is formed of an aluminium co-laminated sheet. The use of a co-laminated sheet comprising aluminium advantageously prevents combustion of the aerosol-generating substrate in the event that the aerosol-generating substrate should be ignited, rather than heated in the intended manner.

The plurality of aerosol-generating granules comprise a porous carrier medium defining a plurality of pores and a second aerosol-generating material releasably retained within the pores of the porous carrier medium.

Unless otherwise stated, references to “aerosol-generating granules” herein refer to the combination of the porous carrier medium and the aerosol-generating material releasably retained within the pores of the porous carrier medium.

The porous carrier medium may be chemically inert. Advantageously, the porous carrier medium is chemically inert with respect to the aerosol-generating material releasably retained within the pores of the porous carrier medium and with respect to the rod of first aerosol-generating material.

The porous carrier medium may be substantially resistant to thermal degradation at temperatures typically reached during use of an aerosol-generating system comprising the substrate. Advantageously, the porous carrier medium does not contribute to aerosol generated during use of an aerosol-generating system comprising the substrate.

The porous carrier medium is coated, impregnated or otherwise loaded with the aerosol-generating material such that the second aerosol-generating material is releasably retained within the pores of the porous carrier medium.

The porous carrier medium may be loaded with the second aerosol-generating material using existing methods known to a person skilled in the art.

Where the second aerosol-generating material is a liquid, a suitable method may comprise steps of: submerging the porous carrier medium in the second aerosol-generating material and soaking the porous carrier medium in the second aerosol-generating material until the second aerosol-generating material penetrates the pores of the porous carrier medium and is adsorbed onto the vesicular surface of the pores of the porous carrier medium.

The method may comprise stirring the porous carrier medium and the second aerosol-generating material.

The method may further comprise drying the porous carrier medium loaded with the second aerosol-generating material at a low temperature such as, for example, 50 degrees Celsius.

Where the second aerosol-generating material is a thermoreversible gel, a suitable method may comprise steps of: heating the second aerosol-generating material to liquefy the second aerosol-generating material, submerging the porous carrier medium in the liquefied second aerosol-generating material, soaking the porous carrier medium in the liquified second aerosol-generating material until the liquified second aerosol-generating material penetrates the pores of the porous carrier medium and is adsorbed onto the vesicular surface of the pores of the porous carrier medium, and cooling the porous carrier medium loaded with the liquefied second aerosol-generating material.

The method may comprise stirring the porous carrier medium and the liquefied second aerosol-generating material.

The method may further comprise drying the porous carrier medium loaded with the liquefied second aerosol-generating material at low temperature such as, for example, 50 degrees Celsius.

The second aerosol-generating material may be loaded and retained within the plurality of pores of the porous carrier medium as a result of capillarity and surface tension phenomena.

The porous carrier medium may have a closed-cell structure. Where the porous carrier medium has a closed-cell structure, the aerosol-generating material releasably retained with the pores of the porous carrier medium may be loaded on an outer surface of the porous carrier medium.

The porous carrier medium may have an open-cell structure. Where the porous carrier medium has an open-cell structure, the aerosol-generating material releasably retained within with the pores of the porous carrier medium may be loaded within the open-cell structure of the porous carrier medium.

The porous carrier medium may be an inorganic porous carrier medium.

The porous carrier medium may comprise one or more of aluminium, calcium, iron, magnesium, and silicon.

The porous carrier medium may comprise one or both of a metal oxide and a metalloid oxide. For example, the porous carrier medium may comprise one or more of aluminium oxide, calcium oxide, iron oxide, magnesium oxide, and silicon dioxide.

The porous carrier medium may comprise a metal carbonate. For example, the porous carrier medium may comprise one or more of calcium carbonate and magnesium carbonate.

The porous carrier medium may comprise one or more of a metal oxide, a metalloid oxide and a metal carbonate. For example, the porous carrier medium may comprise one or more of aluminium oxide, calcium oxide, iron oxide, magnesium oxide, silicon dioxide, calcium carbonate, and magnesium carbonate.

The porous carrier medium may comprise one or both of a metal carbide and a metalloid carbide. For example, the porous carrier medium may comprise silicon carbide.

The porous carrier medium may comprise one or both of a metal nitride and a metalloid nitride. For example, the porous carrier medium may comprise silicon nitride.

Advantageously, the porous carrier medium may comprise silicon dioxide.

Advantageously, the porous carrier medium may comprise one or more of a ceramic, an igneous rock, and a sedimentary rock.

Advantageously, the porous carrier medium may comprise one or more of an igneous rock and a sedimentary rock.

The porous carrier medium may comprise an igneous rock. For example, the porous carrier medium may comprise one or more of basalt, pumice, and scoria.

The porous carrier medium may comprise a sedimentary rock. For example, the porous carrier medium may comprise one or more of expanded clay, limestone, and sandstone.

The porous carrier medium may comprise a ceramic. For example, the porous carrier medium may comprise one or more of a ceramic carbide, a ceramic nitride, a ceramic oxide, and a ceramic silicate.

The porous carrier medium may comprise a sintered ceramic.

The porosity of the porous carrier medium may be greater than or equal to 2 percent, greater than or equal to 5 percent, greater than or equal to 10 percent, greater than or equal to 20 percent, or greater than or equal to 30 percent.

The porosity of the porous carrier medium may be less than or equal to 85 percent, less than or equal to 70 percent, less than or equal to 60 percent, less than or equal to 50 percent or less than or equal to 40 percent.

The porosity of the porous carrier medium may be between 2 percent and 85 percent, between 2 percent and 70 percent, between 2 percent and 60 percent, between 2 percent and 50 percent, or between 2 percent and 40 percent.

The porosity of the porous carrier medium may be between 5 percent and 85 percent, between 5 percent and 70 percent, between 5 percent and 60 percent, between 5 percent and 50 percent, or between 5 percent and 40 percent.

The porosity of the porous carrier medium may be between 10 percent and 85 percent, between 10 percent and 70 percent, between 10 percent and 60 percent, between 10 percent and 50 percent, or between 10 percent and 40 percent.

The porosity of the porous carrier medium may be between 20 percent and 85 percent, between 20 percent and 70 percent, between 20 percent and 60 percent, between 20 percent and 50 percent, or between 20 percent and 40 percent.

The porosity of the porous carrier medium may be between 30 percent and 85 percent, between 30 percent and 70 percent, between 30 percent and 60 percent, between 30 percent and 50 percent, or between 30 percent and 40 percent.

The porosity of the porous carrier medium may be at least 30 percent.

For example, the porous carrier medium may be a ceramic having a porosity of between 30 percent and 70 percent.

For example, the porous carrier medium may be a igneous rock having a porosity of between 30 percent and 85 percent.

For example, the porous carrier medium may be a sedimentary rock having a porosity of between 2 percent and 40 percent.

The porous carrier medium may be mesoporous. That is, the porous carrier medium may comprise pores having a pore size of between 2 nanometres and 50 nanometres.

The porous carrier medium may be macroporous. That is, the porous carrier medium may comprise pores having a pore size of greater than 50 nanometres.

The porous carrier medium may comprise mesopores and macropores.

The porous carrier medium may have a minimum pore size of greater than or equal to 50 nanometres, greater than or equal to 1 micrometre, greater than or equal to 2 micrometres, or greater than equal to 5 micrometres.

The porous carrier medium may have a maximum pore size of less than or equal to 200 micrometres, less than or equal to 100 micrometres, less than or equal to 50 micrometres or less than or equal to 20 micrometres.

The minimum and maximum pore sizes of the porous carrier medium may be greater where the second aerosol-generating material is a gel.

For example, the porous carrier medium may be a ceramic having a pore size of between 1 micrometre and 100 micrometres or between 2 micrometres and 50 micrometres.

The porosity and the pore size distribution of the porous carrier medium may advantageously be selected to optimise releasable retention of an aerosol-generating substrate within the pores of the porous carrier medium. For example, the porosity and the pore size distribution of the porous carrier medium may be selected to optimise releasable retention of an aerosol-generating material within the pores of the porous carrier media based on the viscosity of the aerosol-generating material.

The porosity and the pore size distribution of the porous carrier medium may be naturally occurring properties of the porous carrier medium. For example, where the porous carrier medium comprises an igneous rock or a sedimentary rock, the porosity and the pore size distribution of the porous carrier medium may be naturally occurring properties of the igneous rock or the sedimentary rock.

The porosity and the pore size distribution of the porous carrier medium may be manufactured properties of the porous carrier medium. For example, where the porous carrier medium comprises a ceramic, the porosity and the pore size distribution of the porous carrier medium may be controlled by the manufacturing process.

The porosity and pore size distribution of the porous carrier medium may be measured using one or more of CO₂ gas adsorption, N₂ gas adsorption, and mercury porosimetry.

The plurality of aerosol-generating granules may have a median particle size of greater than or equal to 0.1 millimetres, greater than or equal to 0.3 millimetres, or greater than or equal to 0.5 millimetres.

As used herein, the term “median particle size” refers to the “D50 size”. The D50 size is the particle size which splits the distribution in half, where half of the particles are larger than the D50 size and half of the particles are smaller than the D50 size. The particle size distribution may be determined by laser diffraction. For example, the particle size distribution may be determined by laser diffraction using a Malvern Mastersizer 3000 laser diffraction particle size analyser in accordance with the manufacturer's instructions.

The plurality of aerosol-generating granules may have a median particle size of less than or equal to 3 millimetres, less than or equal to 1.5 millimetres, or less than or equal to 1 millimetre.

The plurality of aerosol-generating granules may have a median particle size of between 0.1 millimetres and 3 millimetres, between 0.1 millimetres and 1.5 millimetres, or between 0.1 millimetres and 1 millimetre.

The plurality of aerosol-generating granules may have a median particle size of between 0.3 millimetres and 3 millimetres, between 0.3 millimetres and 1.5 millimetres, or between 0.3 millimetres and 1 millimetre.

The plurality of aerosol-generating granules may have a median particle size of between 0.5 millimetres and 3 millimetres, between 0.5 millimetres and 1.5 millimetres, or between 0.5 millimetres and 1 millimetre.

The median particle size of the aerosol-generating granules may be selected to provide a desired surface area to volume ratio.

The median particle size of the aerosol-generating granules relative to the pore size distribution of the porous carrier medium may be selected to optimise releasable retention of an aerosol-generating material within the pores of the porous carrier medium.

The plurality of aerosol-generating granules may have a specific surface area of greater than or equal to 0.5 square metres per gram, greater than or equal to 1 square metres per gram, greater than or equal to 2 square metres per gram, or greater than or equal to 5 square metres per gram, or greater than or equal to 10 square metres per gram. As used herein, the term “specific surface area” refers to the surface area as determined by the BET (Brunauer-Emmett-Teller) method in accordance with ISO 9277:2022.

The plurality of aerosol-generating granules may have a specific surface area of less than or equal to 1000 square metres per gram, less than or equal to 800 square metres per gram, less than or equal to 500 square metres per gram, less than or equal to 200 square metres per gram, or less than or equal to 100 square metres per gram.

The plurality of aerosol-generating granules may have a specific surface area of between 0.5 square metres per gram and 1000 square metres per gram, between 0.5 square metres per gram and 800 square metres per gram, between 0.5 square metres per gram and 500 square metres per gram, between 0.5 metres square metres per gram and 200 square metres per gram, or between 0.5 square metres per gram and 100 square metres per gram.

The plurality of aerosol-generating granules may have a specific surface area of between 1 square metre per gram and 1000 square metres per gram, between 1 square metre per gram and 800 square metres per gram, between 1 square metre per gram and 500 square metres per gram, between 1 square metre per gram and 200 square metres per gram, or between 1 square metre per gram and 100 square metres per gram.

The plurality of aerosol-generating granules may have a specific surface area of between 2 square metres per gram and 1000 square metres per gram, between 2 square metres per gram and 800 square metres per gram, between 2 square metres per gram and 500 square metres per gram, between 2 square metres per gram and 200 square metres per gram, or between 2 square metres per gram and 100 square metres per gram.

The plurality of aerosol-generating granules may have a specific surface area of between 5 square metres per gram and 1000 square metres per gram, between 5 square metres per gram and 800 square metres per gram, between 5 square metres per gram and 500 square metres per gram, between 5 square metres per gram and 200 square metres per gram, or between 5 square metres per gram and 100 square metres per gram.

The plurality of aerosol-generating granules may have a specific surface area of between 10 square metres per gram and 1000 square metres per gram, between 10 square metres per gram and 800 square metres per gram, between 10 square metres per gram and 500 square metres per gram, between 10 square metres per gram and 200 square metres per gram, or between 10 square metres per gram and 100 square metres per gram.

The plurality of aerosol-generating granules may have any suitable shape.

Advantageously, the plurality of aerosol-generating granules are substantially spherical. Substantially spherical aerosol-generating granules have a maximum surface area for a given volume. This may be particularly advantageous where the porous carrier medium has a closed-cell structure.

The plurality of aerosol-generating granules may comprise at least 5 aerosol-generating granules, at least 10 aerosol-generating granules, at least 25 aerosol-generating granules, or at least 50 aerosol-generating granules.

The plurality of aerosol-generating granules may comprise less than or equal to 200 aerosol-generating granules, less than or equal to 150 aerosol-generating granules, or less than or equal to 100 granules.

The plurality of aerosol-generating granules may comprise between 5 and 200 aerosol-generating granules, between 5 and 150 aerosol-generating granules, or between 5 and 100 aerosol-generating granules.

The plurality of aerosol-generating granules may comprise between 10 and 200 aerosol-generating granules, between 10 and 150 aerosol-generating granules, or between 10 and 100 aerosol-generating granules.

The plurality of aerosol-generating granules may comprise between 25 and 200 aerosol-generating granules, between 25 and 150 aerosol-generating granules, or between 25 and 100 aerosol-generating granules.

The plurality of aerosol-generating granules may comprise between 50 and 200 aerosol-generating granules, between 50 and 150 aerosol-generating granules, or between 50 and 100 aerosol-generating granules.

Some or all of the plurality of aerosol-generating granules may be dispersed in the first aerosol-generating material.

Some or all of the plurality of aerosol-generating granules may be embedded in the first aerosol-generating material. Preferably, some or all of the plurality of aerosol-generating granules are embedded such that they are immobilised within the rod of first aerosol-generating material.

The ratio of the total envelope volume of the plurality of the aerosol-generating granules to the total volume of the aerosol-generating substrate may be greater than or equal to 0.05. For example, the ratio of the total envelope volume of the plurality of the aerosol-generating granules to the total volume of the aerosol-generating substrate may be greater than or equal to 0.05, or greater than or equal to 0.1 or greater than or equal to 0.15.

The ratio of the total envelope volume of the plurality of the aerosol-generating granules to the total volume of the aerosol-generating substrate may be less than or equal to 0.5.

For example, the ratio of the total envelope volume of the plurality of the aerosol-generating granules to the total volume of the aerosol-generating substrate may be less than or equal to 0.4 or less than or equal to 0.3.

The ratio of the total envelope volume of the plurality of the aerosol-generating granules to the total volume of the aerosol-generating substrate may be between 0.05 and 0.5, between 0.05 and 0.4, or between 0.05 and 0.3.

The ratio of the total envelope volume of the plurality of the aerosol-generating granules to the total volume of the aerosol-generating substrate may be between 0.1 and 0.5, between 0.1 and 0.4, or between 0.1 and 0.3.

The ratio of the total envelope volume of the plurality of the aerosol-generating granules to the total volume of the aerosol-generating substrate may be between 0.15 and 0.5, between 0.15 and 0.4, or between 0.15 and 0.3.

The second aerosol-generating material is in the form of a liquid or a gel.

The second aerosol-generating material may be a liquid aerosol-generating material.

The second aerosol-generating material may be a gel aerosol-generating material. A gel aerosol-generating material may comprise at least one gelling agent.

The second aerosol-generating material comprises a flavourant and an aerosol former.

The second aerosol-generating material may comprise one or more flavourants.

The second aerosol-generating material may comprise one or more natural flavourants.

The second aerosol-generating material may comprise one or more synthetic flavourants.

The second aerosol-generating material may comprise any suitable flavourant. Suitable flavourants include, but are not limited to: menthol; peppermint oil; gamma octalactone; vanillin; ethyl vanillin; methyl salicylate; linalool; bergamot oil; geranium oil; ginger oil; and lemon oil.

The aerosol former may be any suitable known compound or mixture of compounds that, in use, facilitates formation of a dense and stable aerosol. The aerosol former may be substantially resistant to thermal degradation at temperatures typically reached during use of an aerosol-generating system according to the third aspect of the invention.

Examples of suitable aerosol formers include: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Advantageously, the aerosol former may comprise one or more polyhydric alcohols.

More advantageously, the aerosol former comprises one or more polyhydric alcohols selected from the group consisting of propylene glycol, triethylene glycol, 1,3-butanediol and glycerine.

The aerosol former may comprise one or both of glycerine and propylene glycol. The aerosol former may consist of glycerine. The aerosol former may consist of propylene glycol. The aerosol former may consist of a combination of glycerine and propylene glycol.

The second aerosol-generating material may comprise water.

The second aerosol-generating material may comprise a gelling agent.

The second aerosol-generating material may comprise nicotine.

The second aerosol-generating material may be a liquid nicotine formulation.

The second aerosol-generating material may be a gel nicotine formulation.

The second aerosol-generating material may comprise natural nicotine.

The second aerosol-generating material may comprise synthetic nicotine.

The second aerosol-generating material may have a nicotine content of greater than or equal to 0.5 percent by weight, greater than or equal to 1 percent by weight, or greater than or equal to 1.5 percent by weight.

The second aerosol-generating material may have a nicotine content of less than or equal to 10 percent by weight, less than or equal to 5 percent by weight, or less than or equal to 3 percent by weight.

The second aerosol-generating material may have a nicotine content of between 0.5 percent by weight and 10 percent by weight. For example, the second aerosol-generating material may have a nicotine content of between 0.5 percent by weight and 5 percent by weight or between 0.5 percent by weight and 3 percent by weight.

The second aerosol-generating material may have a nicotine content of between 1 percent by weight and 10 percent by weight. For example, the second aerosol-generating material may have a nicotine content of between 1 percent by weight and 5 percent by weight or between 1 percent by weight and 3 percent by weight.

The second aerosol-generating material may have a nicotine content of between 1.5 percent by weight and 10 percent by weight. For example, the second aerosol-generating material may have a nicotine content of between 1.5 percent by weight and 5 percent by weight or between 1.5 percent by weight and 3 percent by weight.

For example, the second aerosol-generating material may have a nicotine content of 2 percent by weight.

The composition of the second aerosol-generating material may advantageously be selected to provide one or more physical properties that optimise releasable retention of the aerosol-generating material within the pores of the porous carrier medium. For example, the composition of the second aerosol-generating material may be selected to provide a viscosity that optimises releasable retention of the second aerosol-generating material within the pores of the porous carrier medium.

The composition of the second aerosol-generating material is different to the composition of the first aerosol-generating material. As described above, releasable retention of the second aerosol-generating material within the pores of the porous carrier medium may advantageously prevent or reduce chemical interactions between components of the first aerosol-generating material and components of the second aerosol-generating material.

The composition of the second aerosol-generating material may be selected to provide a desired aerosolization temperature. For example, the aerosol-former in the second aerosol-generating material may be selected to provide a desired aerosolization temperature.

The aerosolization temperature of the second aerosol-generating material may be substantially the same as the aerosolization temperature of the first aerosol-generating material.

Advantageously, the aerosolization temperature of the second aerosol-generating material may be different to the aerosolization temperature of the first aerosol-generating material. As previously described above, where the aerosolization temperature of the second aerosol-generating material is different to the aerosolization temperature of the first aerosol-generating material, the second aerosol-generating material may generate aerosol earlier or later in the user experience than the first aerosol-generating material. This may advantageously allow for more consistent aerosol generation and delivery to a user.

Without wishing to be bound by theory, the liquid or gel second aerosol-generating material may be retained within the plurality of pores of the porous carrier medium as a result of capillarity and surface tension phenomena that apply to the liquid or gel second aerosol-generating material when it is loaded on the porous carrier medium.

Advantageously, releasably retaining the second aerosol-generating material within the pores of the porous carrier medium prevents or reduces the negative impact of external physical forces, such as pressure, centrifugal forces, shaking motions from handling, or impact forces from being dropped, on the second aerosol-generating material during storage. Such forces might otherwise cause migration of the second aerosol generating material within the rod of first aerosol-generating material, or even leakage of the second aerosol-generating material from the rod, article or device in which it is contained. Such migration and leakage is undesirable because the second aerosol-generating material may interact chemically with the rod of first aerosol-generating material or with the surrounding components of an aerosol-generating device, which may lead to chemical degradation of the second aerosol-generating material, first aerosol-generating material or components of the device. Leakage of the second aerosol-generating material may also cause loss of the second aerosol-generating material, and other problems such as staining if the second aerosol-generating material leaks out of the device. Under warm and humid environmental conditions, the second aerosol-generating material in a gel form may liquify or turn into a liquid-like phase, which may migrate or leak as described above. Furthermore, under warm conditions, the second aerosol-generating material in a liquid or gel form may be lost to sublimation or evaporation. Advantageously, releasably retaining the second aerosol-generating material within the pores of the porous carrier medium on the aerosol-generating granules reduces negative impacts on the second aerosol-generating material caused by variations in environmental conditions. Thus when the second aerosol-generating material is immobilised within the pores of the porous carrier medium of the aerosol-generating granules, the physical stability of the second aerosol-generating material may be enhanced during storage, such that migration of the second aerosol-generating material within the rod of first aerosol-generating material is minimised or prevented, and loss of the second aerosol-generating material from the rod of first aerosol-generating material due to leakage, evaporation or sublimation is also minimised or prevented.

The plurality of aerosol-generating granules is dispersed through the rod of the first aerosol-generating material.

Preferably, the plurality of aerosol-generating granules may be evenly dispersed through the rod of the first aerosol-generating material. Preferably, the plurality of aerosol-generating granules may be substantially uniformly distributed throughout the first aerosol-generating material. The first aerosol-generating material may be considered a matrix. Thus the plurality of aerosol-generating granules may be substantially uniformly distributed throughout a matrix of first aerosol-generating material.

Some or all of the plurality of aerosol-generating granules may be enclosed by the first aerosol-generating material. Some or all of the plurality of aerosol-generating granules may be enclosed within a rod of the first aerosol-generating material.

Some or all of the plurality of aerosol-generating granules may be coated on a surface of the first aerosol-generating material. Some of the aerosol-generating granules may be coated on a surface of the rod of the first aerosol-generating material. Some or all of the plurality of aerosol-generating granules may be coated evenly on a surface of the first aerosol-generating material. Some or all of the plurality of aerosol-generating granules may be coated evenly on the surface of a sheet of first aerosol-generating material. The sheet of first aerosol-generating material may be crimped and gathered to form the rod of first aerosol-generating material.

The aerosol-generating substrate may be manufactured, for instance, with the plurality of aerosol-generating granules substantially uniformly distributed through the rod of first aerosol-generating material. In this instance, the second aerosol-generating material located on aerosol-generating granules that are closer to the heating element will reach a higher temperature earlier than the second aerosol-generating material located on other aerosol-generating granules that are more distant from the heating element of the device. The aerosol-generating granules that are closer to the heating element will reach an aerosolization temperature earlier and the second aerosol-generating material contained within these aerosol-generating granules will volatilise earlier than the second aerosol-generating material within aerosol-generating granules that are more distant from the heating element, which will volatilise later during the user experience.

The plurality of aerosol-generating granules may be unevenly dispersed through the rod of the first aerosol-generating material. The plurality of aerosol-generating granules may be non-uniformly distributed within the first aerosol-generating material. For example, the plurality of aerosol-generating granules may be distributed in the first aerosol-generating material such that there are some areas within the first aerosol-generating material in which aerosol-generating granules are aggregated and other areas within the first aerosol-generating material in which aerosol-generating granules are relatively fewer in number or substantially absent.

The properties of the aerosol generated may thus be even further tuned by the distribution of the granules within the first aerosol-generating material, and, by extension, the aerosol-generating substrate.

For instance, the aerosol-generating substrate may be manufactured with a distribution of granules such that some aerosol-generating granules are aggregated in an area of the rod of first aerosol-generating material in proximity to a heating element when the substrate is in use in a device, while aerosol-generating granules are either relatively fewer in number or substantially absent in areas of the rod of first aerosol-generating material that are more distant from the heating element. This arrangement allows for a greater amount of aerosol to be produced from the aerosol-generating granules in proximity to the heating element even earlier than if the aerosol-generating granules were uniformly distributed throughout the rod of first aerosol-generating material. This may be particularly advantageous when the second aerosol-generating material has a lower aerosolization temperature than the first aerosol-generating material, as a greater amount of aerosol may be released from the second aerosol-generating material early in the heating profile, thus even further reducing or eliminating the problem of “cold puffs.” In conjunction with the relatively lower aerosolization temperature of the second aerosol-generating material shortening the time until an aerosol is generated from this material, the distribution of the aerosol-generating granules within the substrate in proximity to the heater allows for a greater amount of aerosol to be produced at this earlier time because it takes these aerosol-generating granules less time to be heated and release an aerosol.

Alternatively, the aerosol-generating substrate may be manufactured, for instance, with a distribution of aerosol-generating granules such that some aerosol-generating granules are aggregated in an area of the rod of first aerosol-generating material that are distant from a heating element when the substrate is in use in a device, while aerosol-generating granules are either relatively fewer in number or substantially absent in areas of the rod of first aerosol-generating material that are in proximity to the heating element. This arrangement allows for a greater amount of aerosol to be produced from the aerosol-generating granules distant from the heating element even later than if the aerosol-generating granules were uniformly distributed throughout the first aerosol-generating material. This may be particularly advantageous when the second aerosol-generating material has a higher aerosolization temperature than the first aerosol-generating material, as a greater amount of aerosol may be released later in the heating profile. In conjunction with the relatively higher aerosolization temperature of the second aerosol-generating material lengthening the time until an aerosol is generated from this material, the distribution of the aerosol-generating granules within the substrate distant from the heater allows for a greater amount of aerosol to be produced at this later time because it takes these aerosol-generating granules longer to be heated, thus further enhancing the user experience after the first aerosol-generating material has been depleted.

For instance, an aerosol-generating substrate may be manufactured with a distribution of aerosol-generating granules such that some aerosol-generating granules are aggregated in the longitudinal centre of the rod of first aerosol-generating material, while aerosol-generating granules are either relatively fewer in number or substantially absent from on or near the surface of the rod. In such embodiments, the rod of first aerosol-generating material is a cylindrical rod with a central longitudinal axis. We may define a core cylinder that is coaxial with the cylindrical rod of first aerosol-generating material, that is to say, the central longitudinal axis of the core cylinder is shared with or the same as the central longitudinal axis of the rod of first aerosol-generating material. The cylindrical rod of first aerosol-generating material has a radius with length equal to r, the length extending from the center of the cylindrical rod to the exterior surface of the cylindrical rod. The core cylinder has a radius with length equal to r/√2. The cylindrical rod of first aerosol-generating material has a length equal to [symbol] , the length extending all the way from the proximal end of the rod to the distal end of the rod. The core cylinder also has length equal to [symbol] . The volume of the cylindrical rod is equal to πr² [symbol] , while the volume of the core cylinder is equal to φ(r/√2)² [symbol] , or (πr² [symbol] )/2. Thus the core cylinder occupies 50 percent of the volume of the cylindrical rod of first aerosol-generating material. In embodiments in which aerosol-generating granules are aggregated in the longitudinal centre of the cylindrical rod, greater than 60 percent, or greater than 70 percent, or greater than 80 percent, or greater than 90 percent of the total number of aerosol-generating granules dispersed within the cylindrical rod of first aerosol-generating material are located within the volume of the core cylinder. Up to 100 percent of the total number of aerosol-generating granules dispersed within the cylindrical rod of first aerosol-generating material may be located within the volume of the core cylinder. Advantageously, when the substrate is in use in a device with an internal heating element, the heating element may contact or penetrate the aerosol-generating substrate substantially in proximity to the longitudinal centre of the rod, such that the aerosol-generating granules that are aggregated in the longitudinal centre of the rod are also in proximity to the internal heating element. Alternatively, when the substrate is in use in a device with an external heating element, the heating element, which is configured to heat the aerosol-generating substrate from the outside of the aerosol-generating substrate, is distant from the longitudinal centre of the rod, such that the aerosol-generating granules that are aggregated in the longitudinal centre of the rod are also distant from the external heating element.

Alternatively, an aerosol-generating substrate may be manufactured with a distribution of aerosol-generating granules such that some aerosol-generating granules are aggregated on or near the surface of the rod of first aerosol-generating material, while aerosol-generating granules are either relatively fewer in number or substantially absent from the longitudinal centre of the rod. In such embodiments, the core cylinder is defined as above. In embodiments in which aerosol-generating granules are aggregated on or near the surface of the cylindrical rod, less than 40 percent, or less than 30 percent, or less than 20 percent, or less than 10 percent of the total number of aerosol-generating granules dispersed within the cylindrical rod of first aerosol-generating material are located within the volume of the core cylinder. Down to 0 percent of the total number of aerosol-generating granules dispersed within the cylindrical rod of first aerosol-generating material may be located within the volume of the core cylinder. Advantageously, when the substrate is in use in a device with an external heating element, the heating element, which is configured to heat the aerosol-generating substrate from the outside of the aerosol-generating substrate, is distant from the longitudinal centre of the rod, such that the aerosol-generating granules that are aggregated on or near the surface of the rod are in proximity to the external heating element. Alternatively, when the substrate is in use in a device with an internal heating element, the heating element may contact or penetrate the aerosol-generating substrate substantially in proximity to the longitudinal centre of the rod, such that the aerosol-generating granules that are aggregated on or near the surface of the rod are distant from the internal heating element.

Additionally, an aerosol-generating substrate may be manufactured with a distribution of aerosol-generating granules such that some aerosol-generating granules are aggregated at the distal end of the rod of first aerosol-generating material, while aerosol-generating granules are either relatively fewer in number or substantially absent from the proximal end of the rod of first aerosol-generating material. We may define a distal cylinder that shares all dimensions except length with the cylindrical rod of first aerosol-generating material. The distal end of the distal cylinder is coincident with the distal end of the cylindrical rod of first aerosol-generating material, that is to say the distal end of distal cylinder is the same as the distal end of the cylindrical rod of first aerosol-generating material. The cylindrical rod of first aerosol-generating material has a radius with length equal to r, the length extending from the center of the cylindrical rod to the exterior surface of the cylindrical rod. The distal cylinder also has a radius with length equal to r. The cylindrical rod of first aerosol-generating material has a length equal to [symbol] , the length extending all the way from the proximal end of the rod to the distal end of the rod. The distal cylinder has a length equal to [symbol] /2. The volume of the cylindrical rod is equal to πr² [symbol] , while the volume of the distal cylinder is equal to (πr² [symbol] )/2. Thus the distal cylinder occupies 50 percent of the volume of the cylindrical rod of first aerosol-generating material. In embodiments in which aerosol-generating granules are aggregated at the distal end of the cylindrical rod, greater than 60 percent, or greater than 70 percent, or greater than 80 percent, or greater than 90 percent of the total number of aerosol-generating granules dispersed within the cylindrical rod of first aerosol-generating material are located within the volume of the distal cylinder. Up to 100 percent of the total number of aerosol-generating granules dispersed within the cylindrical rod of first aerosol-generating material may be located within the volume of the distal cylinder. Advantageously, in such embodiments, when the substrate is in use in a device with a heating element at the distal end of the aerosol-generating device, the heating element at the distal end of the aerosol generating device may be in proximity to the distal end of the rod of first aerosol-generating material, such that the aerosol-generating granules that are aggregated at the distal end of the rod of first aerosol-generating material are in proximity to the heating element at the distal end of the aerosol-generating device.

Alternatively, an aerosol-generating substrate may be manufactured with a distribution of aerosol-generating granules such that some aerosol-generating granules are aggregated at the proximal end of the rod of first aerosol-generating material, while aerosol-generating granules are either relatively fewer in number or substantially absent from the distal end of the rod of first aerosol-generating material. In such embodiments, the distal cylinder is defined as above. In embodiments in which aerosol-generating granules are aggregated at the proximal end of the cylindrical rod of first aerosol-generating material, less than 40 percent, or less than 30 percent, or less than 20 percent, or less than 10 percent of the total number of aerosol-generating granules dispersed within the rod of first aerosol-generating material are located within the volume of the distal cylinder. Down to 0 percent of the total number of aerosol-generating granules dispersed within the cylindrical rod of first aerosol-generating material may be located within the volume of the distal cylinder. Advantageously, in such embodiments, when the substrate is in use in a device with a heating element at the distal end of the aerosol-generating device, the heating element at the distal end of the aerosol generating device may be in proximity to the distal end of the rod of first aerosol-generating material, such that the aerosol-generating granules that are aggregated at the proximal end of the rod of first aerosol-generating material are distant from the heating element at the distal end of the aerosol-generating device.

In some embodiments, the aerosol-generating substrate may comprise a plurality of first aerosol-generating granules and a plurality of second aerosol-generating granules. The plurality of first aerosol-generating granules may comprise a first porous carrier medium defining a plurality of pores and a second aerosol-generating material releasably retained within the pores of the first porous carrier medium. The second aerosol-generating material may be in the form of a liquid or a gel. The second aerosol-generating material may comprise a flavourant and an aerosol former. The plurality of second aerosol-generating granules may comprise a second porous carrier medium defining a plurality of pores and a third aerosol-generating material releasably retained within the pores or the second porous carrier medium, wherein the third aerosol-generating material is a liquid or a gel. The plurality of first aerosol-generating granules and the plurality of second aerosol-generating granules may be dispersed through the rod of the first aerosol generating material. The third aerosol-generating granules may be different from the second aerosol-generating granules.

The plurality of second aerosol-generating granules may comprise any porous carrier medium described above as suitable for inclusion in the plurality of first aerosol-generating granules.

The second porous carrier medium may have any of the properties described above for the first porous carrier medium.

The third aerosol-generating material may be a liquid aerosol-generating material.

The third aerosol-generating material may be a gel aerosol-generating material.

The third aerosol-generating material may comprise an aerosol former.

The third aerosol-generating material may comprise any aerosol former described above as suitable for inclusion in the first aerosol-generating material or second aerosol-generating material.

The third aerosol-generating material may comprise a flavourant.

The third aerosol-generating material may comprise any flavourant described above as suitable for inclusion in the second aerosol-generating material.

That is, the aerosol-generating substrate may comprise: a rod of first aerosol-generating material; a plurality of first aerosol-generating granules comprising a first porous carrier medium defining a plurality of pores and a second aerosol-generating material releasably retained within the pores of the first porous carrier medium, wherein the second aerosol-generating material is a liquid or a gel comprising a first flavourant and a first aerosol former; and a plurality of second aerosol-generating granules comprising a second porous carrier medium defining a plurality of pores and a third aerosol-generating material releasably retained within the pores of the second porous carrier medium, wherein the third aerosol-generating material is a liquid or a gel comprising a second flavourant and a second aerosol former, wherein the plurality of first aerosol-generating granules and the plurality of second aerosol-generating granules are dispersed through the rod, and the first aerosol-generating granules are different from the second aerosol-generating granules.

The third aerosol-generating material may comprise water.

The third aerosol-generating material may comprise a gelling agent.

The third aerosol-generating material may comprise nicotine.

The third aerosol-generating material may be a liquid nicotine formulation.

The third aerosol-generating material may be a gel nicotine formulation.

The third aerosol-generating material may comprise natural nicotine.

The third aerosol-generating material may comprise synthetic nicotine.

The third aerosol-generating material may have a nicotine content of greater than or equal to 0.5 percent by weight, greater than or equal to 1 percent by weight, or greater than or equal to 1.5 percent by weight.

The third aerosol-generating material may have a nicotine content of less than or equal to 10 percent by weight, less than or equal to 5 percent by weight, or less than or equal to 3 percent by weight.

The third aerosol-generating material may have a nicotine content of between 0.5 percent by weight and 10 percent by weight. For example, the third aerosol-generating material may have a nicotine content of between 0.5 percent by weight and 5 percent by weight or between 0.5 percent by weight and 3 percent by weight.

The third aerosol-generating material may have a nicotine content of between 1 percent by weight and 10 percent by weight. For example, the third aerosol-generating material may have a nicotine content of between 1 percent by weight and 5 percent by weight or between 1 percent by weight and 3 percent by weight.

The third aerosol-generating material may have a nicotine content of between 1.5 percent by weight and 10 percent by weight. For example, the third aerosol-generating material may have a nicotine content of between 1.5 percent by weight and 5 percent by weight or between 1.5 percent by weight and 3 percent by weight.

For example, the third aerosol-generating material may have a nicotine content of 2 percent by weight.

The composition of the third aerosol-generating material may advantageously be selected to provide one or more physical properties that optimise releasable retention of the aerosol-generating material within the pores of the second porous carrier medium. For example, the composition of the third aerosol-generating material may be selected to provide a viscosity that optimises releasable retention of the third aerosol-generating material within the pores of the second porous carrier medium.

The second porous carrier medium of the second aerosol-generating granules may be substantially the same as the first porous carrier medium of the first aerosol-generating granules.

The second porous carrier medium of the second aerosol-generating granules may be different to the first porous carrier medium of the first aerosol-generating granules.

The composition of the second porous carrier medium may be different to the composition of the first porous carrier medium. For example, the second porous carrier medium may comprise an igneous rock, such as basalt, and the first porous carrier medium may comprise a sedimentary rock, such as limestone.

One or more physical properties of the second porous carrier medium may be different to one or more physical properties of the first porous carrier medium. For example, the second porous carrier medium may have one or both of a different porosity and a different median particle size to the first porous carrier medium.

The composition of the third aerosol-generating material may be substantially the same as the composition of the second aerosol-generating material.

Advantageously, the third aerosol-generating material may have a different composition to the second aerosol-generating material.

The second aerosol-generating material may comprise a first flavourant and the third aerosol-generating material may comprise a second flavourant and the second flavourant may be different to the first flavourant. For example, the second flavourant may be menthol and the first flavourant may be vanillin.

The second aerosol-generating material may comprise a second aerosol former and the third aerosol-generating material may comprise a second aerosol former and the second aerosol former may be different to the first aerosol former. For example, the second aerosol former may be glycerine and the first aerosol former may be propylene glycol.

The second porous carrier medium of the second aerosol-generating granules may be substantially the same as the first porous carrier medium of the first aerosol-generating granules and the third aerosol-generating material may have a different composition to the second aerosol-generating material.

The second porous carrier medium of the second aerosol-generating granules may be different to the first porous carrier medium of the first aerosol-generating granules and the composition of the third aerosol-generating material may be substantially the same as the composition of the second aerosol-generating material.

The second porous carrier medium of the second aerosol-generating granules may be different to the first porous carrier medium of the first aerosol-generating granules and the third aerosol-generating material may have a different composition to the second aerosol-generating material.

The composition of the third aerosol-generating material may be different to the composition of the first aerosol-generating material. Releasable retention of the third aerosol-generating material within the pores of the porous carrier medium may advantageously prevent or reduce chemical interactions between components of the first aerosol-generating material and components of the third aerosol-generating material.

Advantageously, the composition of each of the first aerosol-generating material, the second aerosol-generating material, and the third aerosol-generating material may be different.

The aerosolization temperature of the third aerosol-generating material may be substantially the same as the aerosolization temperature of the first aerosol-generating material.

Advantageously, the aerosolization temperature of the third aerosol-generating material may be different to the aerosolization temperature of the first aerosol-generating material. Where the aerosolization temperature of the third aerosol-generating material is different to the aerosolization temperature of the first aerosol-generating material, the third aerosol-generating material may generate aerosol earlier or later in the user experience than the first aerosol-generating material. This may advantageously allow for more consistent aerosol generation and delivery to a user.

The aerosolization temperature of the third aerosol-generating material may be substantially the same as the aerosolization temperature of the second aerosol-generating material.

Advantageously, the aerosolization temperature of the third aerosol-generating material may be different to the aerosolization temperature of the second aerosol-generating material. Where the aerosolization temperature of the third aerosol-generating material is different to the aerosolization temperature of the second aerosol-generating material, the third aerosol-generating material may generate aerosol earlier or later in the user experience than the second aerosol-generating material. This may advantageously allow for more consistent aerosol generation and delivery to a user.

Advantageously, the aerosolization temperature of each of the first aerosol-generating material, the second aerosol-generating material, and the third aerosol-generating material may be different. For example, the aerosolization temperature of the second aerosol-generating material may be lower than the aerosolization temperature of the first aerosol-generating material and the aerosolization temperature of the third aerosol-generating material may be higher than the aerosolization temperature of the first aerosol-generating material. Where the aerosolization temperature of the second aerosol-generating material is lower than the aerosolization temperature of the first aerosol-generating material and the aerosolization temperature of the third aerosol-generating material is higher than the aerosolization temperature of the first aerosol-generating material, the second aerosol-generating material may generate aerosol earlier in the user experience than the first aerosol-generating material and the third aerosol-generating material may generate aerosol later in the user experience than the first aerosol-generating material. This may advantageously allow for more consistent aerosol generation and delivery to a user.

Preferably, both the plurality of first aerosol-generating granules and the plurality of second aerosol-generating granules are evenly dispersed through the rod of the first aerosol-generating material. Preferably, both the plurality of first aerosol-generating granules and the plurality of second aerosol-generating granules are substantially uniformly distributed throughout the first aerosol-generating material. The first aerosol-generating material may be considered a matrix. Thus both of the plurality of first aerosol-generating granules and the plurality of second aerosol-generating granules may be substantially uniformly distributed throughout a matrix of first aerosol-generating material.

Preferably, both the plurality of first aerosol-generating granules and the plurality of second aerosol-generating granules are randomly interspersed. Preferably, both of the plurality of first aerosol-generating granules and the plurality of second aerosol-generating granules are both randomly interspersed and evenly dispersed through the rod of first aerosol-generating material. However, other distributions of the plurality of first and the plurality of second aerosol-generating granules within the rod first aerosol-generating material will be apparent to the skilled person.

One or both of the plurality of first and the plurality of second aerosol-generating granules may be evenly dispersed through the rod of first aerosol-generating material. One or both of the plurality of first and the plurality of second of aerosol-generating granules may be unevenly dispersed through the rod of first aerosol-generating material. One or both of the plurality of first and the plurality of second of aerosol-generating granules may be non-uniformly distributed within the first aerosol-generating material. For example, the plurality of first aerosol-generating granules may be evenly dispersed through the rod of first aerosol-generating material, while the plurality of second aerosol-generating granules may be distributed in the rod of first aerosol-generating material such that there are some areas within the rod of first aerosol-generating material in which the plurality of second aerosol-generating granules are aggregated and other areas within the first aerosol-generating material in which the plurality of second aerosol-generating granules are relatively fewer in number or substantially absent. Other arrangements will be apparent to the skilled person.

Preferably, both the plurality of first and the plurality of second aerosol-generating granules are randomly interspersed and evenly dispersed through the rod of first aerosol-generating material. This may be particularly advantageous when the plurality of first aerosol-generating granules comprises a second aerosol-generating material with a lower aerosolization temperature than the first aerosol-generating material, and the plurality of second aerosol-generating granules comprises a third aerosol-generating material with a higher aerosolization temperature than the first aerosol-generating material. As explained above, the use of a second aerosol-generating material with a lower aerosolization temperature than the first aerosol-generating material may reduce or eliminate the problem of “cold puffs,” and the use of a third aerosol-generating material with a higher aerosolization temperature than the first aerosol-generating material may lengthen the user experience after the first aerosol-generating material has been depleted.

Alternatively, the aerosol-generating substrate may be manufactured with a distribution of granules such that the plurality of first aerosol-generating granules are aggregated in an area of the rod of first aerosol-generating material in proximity to a heating element when the substrate is in use in a device, and the plurality of first aerosol-generating granules is either relatively fewer in number or substantially absent in areas of the rod of first aerosol-generating material that are more distant from the heating element. Within the same substrate, the plurality of second aerosol-generating granules may be aggregated in areas of the rod of first aerosol-generating material that are distant from a heating element when the substrate is in use in a device, while the plurality of second aerosol-generating granules are either relatively fewer in number or substantially absent in areas of the rod of first aerosol-generating material that are in proximity to the heating element.

For instance, in embodiments in which the plurality of first aerosol-generating granules are aggregated in the longitudinal centre of a cylindrical rod and the plurality of second aerosol-generating granules are aggregated on or near the surface of the cylindrical rod, greater than 60 percent, or greater than 70 percent, or greater than 80 percent, or greater than 90 percent of the total number of first aerosol-generating granules dispersed within the cylindrical rod of first aerosol-generating material are located within the volume of the core cylinder, as defined above. Up to 100 percent of the total number of aerosol-generating granules dispersed within the cylindrical rod of first aerosol-generating material may be located within the volume of the core cylinder. Less than 40 percent, or less than 30 percent, or less than 20 percent, or less than 10 percent of the total number of second aerosol-generating granules dispersed within the cylindrical rod of first aerosol-generating material are located within the volume of the core cylinder. Down to 0 percent of the total number of second aerosol-generating granules dispersed within the cylindrical rod of first aerosol-generating material may be located within the volume of the core cylinder. Such arrangements may be particularly advantageous when the substrate is in use in aerosol-generating device with an internal heating element.

In embodiments in which the plurality of first aerosol-generating granules are aggregated at the distal end of the rod of first aerosol-generating material and the plurality of second aerosol-generating granules are aggregated at the proximal end of the rod of first aerosol-generating material, greater than 60 percent, or greater than 70 percent, or greater than 80 percent, or greater than 90 percent of the total number of first aerosol-generating granules dispersed within the cylindrical rod of first aerosol-generating material are located within the volume of the distal cylinder, as defined above. Up to 100 percent of the total number of first aerosol-generating granules dispersed within the cylindrical rod of first aerosol-generating material may be located within the volume of the distal cylinder. Less than 40 percent, or less than 30 percent, or less than 20 percent, or less than 10 percent of the total number of second aerosol-generating granules dispersed within the rod of first aerosol-generating material are located within the volume of the distal cylinder. Down to 0 percent of the total number of second aerosol-generating granules dispersed within the cylindrical rod of first aerosol-generating material may be located within the volume of the distal cylinder. Such arrangements may be particularly advantageous when the substrate is in use in aerosol-generating device with an heating element at the distal end of the aerosol-generating device.

Both of the above arrangements may be particularly advantageous when the plurality of first aerosol-generating granules comprises a second aerosol-generating material with a lower aerosolization temperature than the first aerosol-generating material, and the plurality of second aerosol-generating granules comprises a third aerosol-generating material with a higher aerosolization temperature than the first aerosol-generating material. Due to their proximity to the heating element, the plurality of first aerosol-generating granules comprising the second aerosol-generating material will release a greater amount of aerosol earlier in the heating profile than if they were evenly distributed within the first aerosol-generating material. Due to their distance from the heating element, the plurality of second aerosol-generating granules comprising the third aerosol-generating material will release a greater amount of aerosol later in the heating profile than if they were evenly distributed within the first aerosol-generating material. The advantage of such arrangements has been described above with respect to the individual pluralities of granules. Distribution of the two pluralities of aerosol-generating granules within the first aerosol-generating material in this manner allows for tuning and optimization of the user experience.

According to the present disclosure, there is provided an aerosol-generating article comprising the aerosol-generating substrate. Any features described above in relation to the aerosol-generating substrate may be applicable to the aerosol-generating article.

The aerosol-generating article may be for use with an electrical aerosol-generating device. The aerosol-generating article may comprise a plurality of elements. The plurality of elements may be assembled in the form of a rod.

The plurality of elements may include an upstream element. The plurality of elements may include the rod of first aerosol-generating material within the aerosol-generating substrate. The plurality of elements may include a support element. The plurality of elements may include an aerosol-cooling element. The plurality of elements may include a mouthpiece element.

The aerosol-generating article may comprise a downstream section downstream of the aerosol-generating substrate. The downstream section may comprise at least one hollow tubular element. The downstream section may optionally comprise a mouthpiece element. The mouthpiece element may comprise a mouthpiece filter segment, and optionally, a mouth-end recess downstream of the mouthpiece element. The at least one hollow tubular element may comprise one or both of an aerosol-cooling element and a support element.

The aerosol-generating article may comprise an intermediate hollow section. The intermediate hollow section may be located between the rod of aerosol-generating substrate and the mouthpiece element. The intermediate hollow section may comprise one or both of the support element and the aerosol-cooling element. The intermediate hollow section may consist of one or both of the support element and the aerosol-cooling element.

The upstream element may be located at an upstream end of the article. The aerosol-generating substrate may be located downstream, for example immediately downstream, of the upstream element. Alternatively, the aerosol-generating substrate may be located at an upstream end of the article, for example where no upstream element is present. The support element may be located downstream, for example immediately downstream, of the aerosol-generating substrate. The aerosol-cooling element may be located downstream, for example immediately downstream, of the support element. The mouthpiece element may be located downstream, for example immediately downstream, of the aerosol-cooling element. The mouthpiece element may be located at a downstream end, or mouth end, of the article.

The upstream element may advantageously prevent direct physical contact with an upstream end of the aerosol-generating substrate. The upstream element may also advantageously reduce the likelihood of material from the aerosol-generating substrate falling out of the article. The support element may advantageously provide support to the article and help to properly locate other components of the article. The aerosol-cooling element may advantageously allow an aerosol to cool so it is a more desirable temperature when it reaches a user. The mouthpiece element may advantageously act as a filter.

The elements of the aerosol-generating article may be assembled by means of a suitable wrapper, for example a cigarette paper. A cigarette paper may be any suitable material for wrapping components of an aerosol-generating article in the form of a rod. Suitable materials for the wrapper are well-known in the art. The cigarette paper may grip the component elements of the aerosol-generating article when the article is assembled. The cigarette paper may hold component elements in position within the rod.

The upstream element may be in the form of a plug, for example a porous plug. The upstream element may comprise one or more longitudinally extending cavities. The upstream element may comprise a slit or aperture. The slit or aperture may extend from the upstream end to the downstream end of the upstream element. The slit of aperture may be suitable for allowing a heating pin, rod or blade to pass therethrough in use. The upstream element may be made of a porous material. The upstream element may be made of the same material as used for one of the other components of the aerosol-generating article, such as the mouthpiece element, the aerosol-cooling element, or the support element. The upstream element may comprise, or be formed from, one or more of a filter material, ceramic, polymer material, cellulose acetate, cardboard, zeolite or aerosol-generating substrate. It may be preferable that the upstream element comprises, or is formed from, cellulose acetate, for example a plug of cellulose acetate.

The upstream element may have an external diameter that is approximately equal to the external diameter of the aerosol-generating article. The upstream element may have an external diameter of between 5 and 12, 5 and 10, or 5 and 8, 6 and 12, 6 and 10, or 6 and 8 millimetres. The upstream element may have an external diameter of approximately 7.2 millimetres.

The upstream element may have a length of between 1 and 10, 3 and 8, or 4 and 6 millimetres. The upstream element may have a length of about 5 millimetres.

Advantageously, the upstream element prevents direct physical contact with the upstream end of the aerosol-generating substrate. In particular, where the aerosol-generating substrate comprises a susceptor element, the upstream element may prevent direct physical contact with the upstream end of the susceptor element.

The support element may comprise, or be, a hollow tube, for example a substantially cylindrical hollow tube. The hollow tube may define an internal cavity. The internal cavity may extend in the longitudinal direction. Airflow through the internal cavity may be substantially unrestricted. Thus, the hollow tube may not substantially contribute to a resistance to draw (RTD) of the article. A thickness of the wall of the hollow tube may be between 2 and 4 millimetres.

The support element may be formed from any suitable material or combination of materials. For example, the support element may be formed from one or more materials selected from the group consisting of: cellulose acetate; cardboard; crimped paper, such as crimped heat resistant paper or crimped parchment paper; and polymeric materials, such as low density polyethylene (LDPE). In a preferred embodiment, the support element is formed from cellulose acetate. Other suitable materials include polyhydroxyalkanoate (PHA) fibres. It may be particularly preferred that the support element comprises or is formed from cellulose acetate.

The support element may have an external diameter that is approximately equal to the external diameter of the aerosol-generating article. The support element may have an external diameter of between 5 and 12, 5 and 10, or 5 and 8, 6 and 12, 6 and 10, or 6 and 8 millimetres. The support element may have an external diameter of approximately 7.2 millimetres.

A peripheral wall of the support element may have a thickness of at least 1, 1.5 or 2 millimetres, for example where the support element comprises or is a second hollow tube.

The support element may have a length of at least 5, 6, 7 or 8 millimetres. Alternatively or in addition, the support element may have a length of less than 15, 12 or 10 millimetres.

The aerosol-cooling element may comprise, or be, a second hollow tube, for example a substantially cylindrical second hollow tube. The second hollow tube may define a second internal cavity. The second internal cavity may extend in the longitudinal direction. Airflow through the second internal cavity may be substantially unrestricted. Thus, the second hollow tube may not substantially contribute to a resistance to draw (RTD) of the article. A thickness of the wall of the second hollow tube may be between 1 and 3 millimetres.

The aerosol-cooling element may comprise, or be formed from, any suitable material or combination of materials. For example, the aerosol-cooling element may comprise or be formed from one or more materials selected from the list consisting of: cellulose acetate; cardboard; crimped paper, such as crimped heat resistant paper or crimped parchment paper; and polymeric materials, such as low density polyethylene (LDPE). Other suitable materials include polyhydroxyalkanoate (PHA) fibres. It may be preferable that the aerosol-cooling element comprises or is formed from cellulose acetate.

The aerosol-cooling element may have an external diameter that is approximately equal to the external diameter of the aerosol-generating article. The aerosol-cooling element may have an external diameter of between 5 and 12, 5 and 10, or 5 and 8, 6 and 12, 6 and 10, or 6 and 8 millimetres. The aerosol-cooling element may have an external diameter of approximately 7.2 millimetres.

The aerosol-cooling element may have an internal diameter of at least about 2, 2.5, or 3 millimetres, for example where the aerosol-cooling element comprises or is a second hollow tube.

A peripheral wall of the aerosol-cooling element may have a thickness of less than about 2.5, 1.5, 1.25, 1, 0.9, or 0.8 millimetres, for example where the aerosol-cooling element comprises or is a second hollow tube.

The aerosol-cooling element may have a length of at least 5, 6, 7 or 8 millimetres. Alternatively or in addition, the aerosol-cooling element may have a length of less than 15, 12 or 10 millimetres.

The mouthpiece element may comprise a filtration material, for example a fibrous filtration material. The mouthpiece element may comprise, or be, a plug of cellulose acetate.

The mouthpiece element may have an external diameter that is approximately equal to the external diameter of the aerosol-generating article. The mouthpiece element may have an external diameter of between 5 and 12, 5 and 10, or 5 and 8, 6 and 12, 6 and 10, or 6 and 8 millimetres. The mouthpiece element may have an external diameter of approximately 7.2 millimetres.

The mouthpiece element may have a length of at least 5, 8 or 10 millimetres. Alternatively or in addition, the mouthpiece element may have a length of less than 25, 20 or 15 millimetres. The mouthpiece element may have a length of approximately 12 millimetres.

Advantageously, a longer mouthpiece element may be more resilient to deformation, or better adapted to recover its initial shape after deformation, and may provide for improved grip by the consumer to facilitate insertion of the aerosol-generating article into a heating device. In addition, a longer mouthpiece element may provide a higher level of filtration and removal of undesirable aerosol constituents so that a higher quality aerosol can be delivered. In addition, the use of a longer mouthpiece element enables a more complex mouthpiece to be provided since there is more space for the incorporation of mouthpiece components such as capsules, threads and restrictors.

The aerosol-generating article may have an overall length of between 38 and 70, 40 and 70, 42 and 70, 38 and 60, 40 and 60, or 42 and 60, 38 and 50, 40 and 50, or 42 and 50 millimetres. The aerosol-generating article may have an overall length of around 45 millimetres.

The aerosol-generating article may have an external diameter of at least about 5, 6, or 7 millimetres. The aerosol-generating article may have an external diameter of less than about 12, 10 or 8 millimetres. The aerosol-generating article may have an external diameter of about 7.25 millimetres.

According to the present disclosure, there is provided an aerosol-generating system comprising an aerosol-generating article as described above and an aerosol-generating device.

The aerosol-generating device may be an electrical aerosol-generating device. The aerosol-generating device may be engageable with, and disengageable from, the aerosol-generating article. For example, the aerosol-generating device may be configured to receive at least a portion of the aerosol-generating article.

The aerosol-generating device may be configured to heat the aerosol-generating article. The aerosol-generating device may be configured to reach maximum temperature of about 150 degrees Celsius to about 350 degrees Celsius. The aerosol-generating device may be configured to heat the aerosol-generating article to a maximum temperature of about 150 degrees Celsius to about 350 degrees Celsius. The aerosol-generating device may be configured to resistively heat the aerosol-generating article. The device may comprise a heating element. The heating element may be configured to contact, for example penetrate, the aerosol-generating substrate in use. Such a heating element is known as an internal heating element. The heating element may be configured to be resistively heated. The heating element may comprise an electrically resistive track. In use, a current may be passed through the track to resistively heat the track. The heating element may be in the form of a pin, rod or blade.

The aerosol-generating device may be configured to inductively heat the aerosol-generating article. The device may comprise an inductor, such as an inductor coil. The device may be configured to generate a fluctuating electromagnetic field. In use, this fluctuating electromagnetic field may induce eddy currents in a susceptor material, for example a susceptor material within the aerosol-generating substrate, or a susceptor material of a heating element of the device, or both. Where the device comprises an inductively heatable heating element, such a heating element may be configured to contact, for example penetrate, the aerosol-generating substrate in use. The heating element may be in the form of a pin, rod or blade. The eddy currents may heat up the susceptor material and thereby heat up the aerosol-generating substrate in use.

The heating element may be configured to heat the aerosol-generating substrate from the outside of the aerosol-generating substrate in use. Such heating elements are known as external heating elements.

According to the present disclosure, there is provided a method of forming an aerosol-generating substrate. The method may comprise providing an aerosol-generating material and a plurality of aerosol-generating granules. The method may comprise a step of coating the plurality of aerosol-generating granules onto the aerosol-generating material to form a coated first aerosol-generating material. The method may comprise a step of gathering the coated first aerosol-generating material into a rod to form the aerosol-generating substrate.

Thus there is provided a method of forming an aerosol-generating substrate comprising:
providing a first aerosol-generating material and a plurality of aerosol-generating granules;
coating the plurality of aerosol-generating granules onto the first aerosol-generating material to form a coated first aerosol-generating material; and
gathering the coated first aerosol-generating material into a rod to form the aerosol-generating substrate.

Any features described in relation to the first aerosol-generating material, plurality of aerosol-generating granules, porous carrier medium or second aerosol-generating material above may be applicable to the corresponding first aerosol-generating material, plurality of aerosol-generating granules, porous carrier medium or second aerosol-generating material in this method.

The first aerosol-generating material may comprise, or may be in the form of, one or more of: cut-filler, powder particles, granules, pellets, shreds, spaghettis, strips, sheets or gel. The cut width of the cut-filler may be between 0.3 and 2, 0.5 and 1.2, or 0.6 and 0.9 millimetres. The skilled person would be aware of appropriate methods for providing such an aerosol-generating material.

For example, the first aerosol-generating material may be provided by:
forming a slurry, for example a slurry comprising plant material, preferably tobacco material;
homogenising the slurry;
casting the slurry; and
drying the slurry to form the first aerosol-generating material.

The first aerosol-generating material may be provided by first forming a slurry. The slurry may comprise one or more of the following: plant material, water, one or more binders, one or more aerosol-formers, tobacco particles, tobacco fibres, non-tobacco fibres, one or more humectants, one or more plasticisers, one or more flavourants, one or more fillers, one or more aqueous solvents and one or more non-aqueous solvents. Thus, forming the slurry may comprise mixing one or more of the above constituents of the slurry.

The plant material may comprise one or both of a tobacco material and a herbaceous material. The plant material may be shredded. For example, the plant material may be or comprise a finely shredded tobacco material. The plant material may comprise or be in the form of a powder such as tobacco powder.

Where the slurry comprises tobacco particles, the tobacco particles may have a particle size distribution having a D10 tobacco particle size, a D50 tobacco particle size and a D90 tobacco particle size.

The D 10 tobacco particle size may be between 1 and 20, or 1 and 10 microns. The D 10 tobacco particle size may be around 3 microns.

The D90 tobacco particle size may be between 40 and 200 or 40 and 100 microns. The D90 tobacco particle size may be around 70 microns.

Suitable binders are well-known in the art and include, but are not limited to, natural pectins, such as fruit, citrus or tobacco pectins; guar gums, such as hydroxyethyl guar and hydroxypropyl guar; locust bean gums, such as hydroxyethyl and hydroxypropyl locust bean gum; alginate; starches, such as modified or derivatised starches; celluloses, such as methyl, ethyl, ethylhydroxymethyl and carboxymethyl cellulose; tamarind gum; dextran; pullulan; konjac flour; xanthan gum and the like. It may be particularly preferable for the binder to be or comprise guar.

Suitable aerosol-formers are well-known in the art and include, but are not limited to, polyhydric alcohols, such as propylene glycol, polyethylene glycol, triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

Forming the slurry may comprise pre-mixing one or more binders with one or more aerosol-formers to form a pre-mixture. Forming the slurry may comprise mixing further ingredients with the pre-mixture.

Advantageously, pre-mixing the binder and the aerosol-former may reduce the likelihood of the binder gelling, for example when the binder contacts water. Such gelling may lead to an unintended non-uniform mixing of the slurry.

Homogenising the slurry may comprise mixing the slurry using a mixing apparatus such as a high-shear mixer.

Casting the slurry may comprise casting the slurry onto a support surface. The support surface may be a surface of a moving conveyor belt.

Drying the slurry may form a sheet of first aerosol-generating material.

As described above, the plurality of aerosol-generating granules comprise a porous carrier medium defining a plurality of pores and a second aerosol-generating material releasably retained within the pores of the porous carrier medium. The second aerosol-generating material comprises a flavourant and an aerosol former.

The method may comprise a step of coating the plurality of aerosol-generating granules onto the first aerosol-generating material to form a coated first aerosol-generating material.

The plurality of aerosol-generating granules may be coated onto the surface of the first aerosol-generating material by suitable means as known in the art, such as spreading, spraying, size pressing or doctor blading.

The method may comprise a step of gathering the coated first aerosol-generating material into a rod to form the aerosol-generating substrate.

The skilled person will be aware of appropriate methods for forming a substrate in which the plurality of aerosol-generating granules is unevenly dispersed through the rod of first aerosol-generating material. For instance, in the step of gathering the coated first aerosol-generating material, the coated first aerosol-generating material could be wrapped with another aerosol-generating material, which may be, for instance, sheets of homogenised plant material that are not coated with, and do not contain, aerosol-generating granules. This would form a rod of first-aerosol generating material in which granules are aggregated in the longitudinal centre of the rod of first aerosol-generating material, while granules are either relatively fewer in number or substantially absent from on or near the surface of the rod. The skilled person will be aware of appropriate methods for forming a substrate in which the aerosol-generating granules are distributed in other arrangements within the rod of first aerosol-generating material, such as aggregated on or near the surface of the rod, or aggregated near the proximal or distal end of the rod.

The plurality of aerosol-generating granules may be a plurality of first aerosol-generating granules comprising a first porous carrier medium defining a plurality of pores and a second aerosol-generating material releasably retained within the pores of the first porous carrier medium; and a plurality of second aerosol-generating granules comprising a second porous carrier medium defining a plurality of pores and a third aerosol-generating material releasably retained within the pores of the second porous carrier medium, wherein the first aerosol-generating granules are different from the second aerosol-generating granules

The second aerosol generating material may comprise a first aerosol former and a first flavourant.

The third aerosol-generating material may comprise a second aerosol former and a second flavourant.

One or more physical properties of the second porous carrier medium may be different to one or more physical properties of the first porous carrier medium. For example, the second porous carrier medium may have one or both of a different porosity and a different median particle size to the first porous carrier medium.

Advantageously, the third aerosol-generating material may have a different composition to the second aerosol-generating material.

The first aerosol former may be different to the second aerosol former.

The second flavourant may be different to the first flavourant.

Advantageously, the composition of each of the first aerosol-generating material, the second aerosol-generating material, and the third aerosol-generating material may be different.

Advantageously, the aerosolization temperature of each of the first aerosol-generating material, the second aerosol-generating material, and the third aerosol-generating material may be different.

According to the present disclosure, there is provided a method of forming an aerosol-generating substrate comprising:
providing a first aerosol-generating material, a plurality of first aerosol-generating granules and a plurality of second aerosol-generating granules;
coating the plurality of first aerosol-generating granules and the plurality of second aerosol-generating granules onto the first aerosol-generating material to form a coated first aerosol-generating material; and
gathering the coated first aerosol-generating material into a rod to form the aerosol-generating substrate.

Any features described in relation to an aerosol-forming substrate above may be applicable to the aerosol-generating substrate of this second method.

The plurality of first aerosol-generating granules and the plurality of second aerosol-generating granules may be coated on the surface of the same sheet of first aerosol-generating material. Alternatively, the plurality of first aerosol-generating granules may be coated on one sheet of first aerosol-generating material and the plurality of second aerosol-generating granules coated on another sheet of first aerosol-generating material, prior to being arranged in alternating stacked sheets and being gathered into a rod. The plurality of first and the plurality of second aerosol-generating granules may thus be randomly interspersed and evenly dispersed through the rod of first aerosol-generating material.

Alternatively, the plurality of first and the plurality of second aerosol-generating granules may be unevenly dispersed through the rod of first aerosol-generating material. This may be accomplished by arranging and wrapping coated sheets comprising the different pluralities of aerosol-generating granules in a manner similar to that described above for embodiments in which a single plurality of granules is unevenly dispersed through the rod, as will be apparent to the skilled person.

According to the present disclosure, there is provided a method of forming an aerosol-generating article comprising the method described above.

The method may comprise preparing a rod of the aerosol-generating substrate.

The method may comprise assembling the aerosol-generating article from a plurality of components, the plurality of components including the aerosol-generating substrate, for example the rod of first aerosol-generating material within the aerosol-generating substrate.

The method may comprise circumscribing components of the aerosol-generating article in a wrapper, for example circumscribing in a wrapper one or more of an upstream element, an aerosol-generating substrate, an aerosol-cooling element, a support element and a mouthpiece element.

The invention will now be further described, by way of example only, with reference to the accompanying drawings in which:

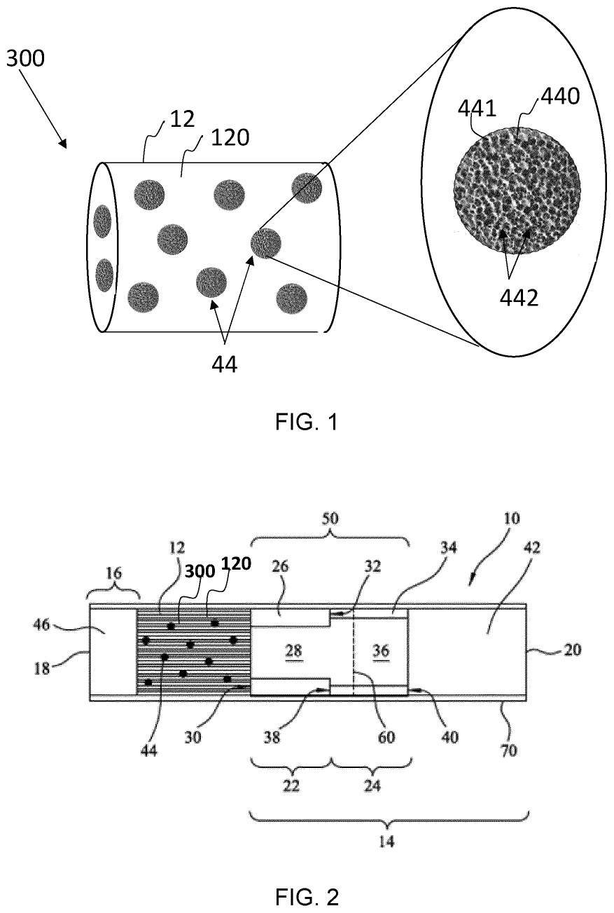

FIG. 1 shows a schematic view of a first embodiment of an aerosol-generating substrate, with a magnified view of an aerosol-generating granule in inset;

FIG. 2 shows a schematic longitudinal cross-sectional view of a first embodiment of an aerosol-generating article;

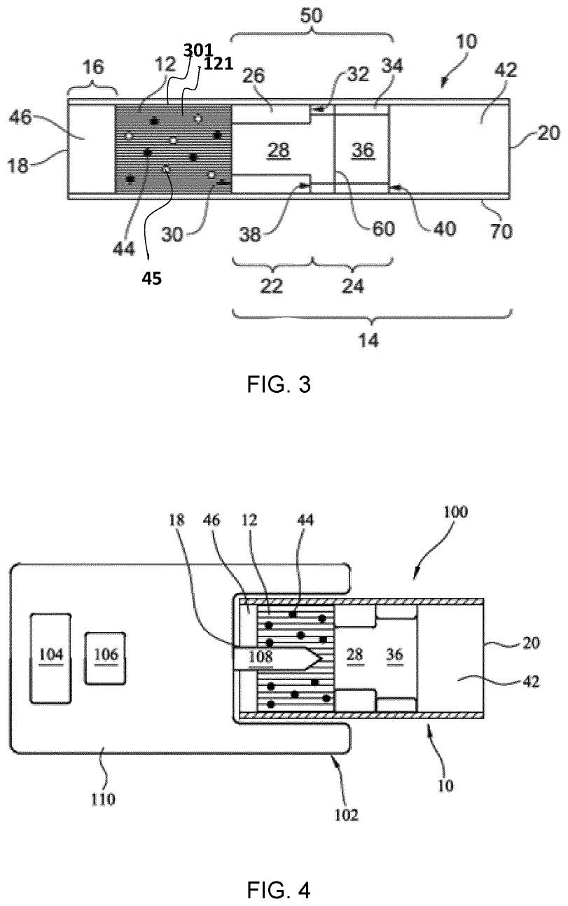

FIG. 3 shows a schematic longitudinal cross-sectional view of a second embodiment of an aerosol-generating article;

FIG. 4 shows a schematic longitudinal cross-sectional view of an aerosol-generating system;

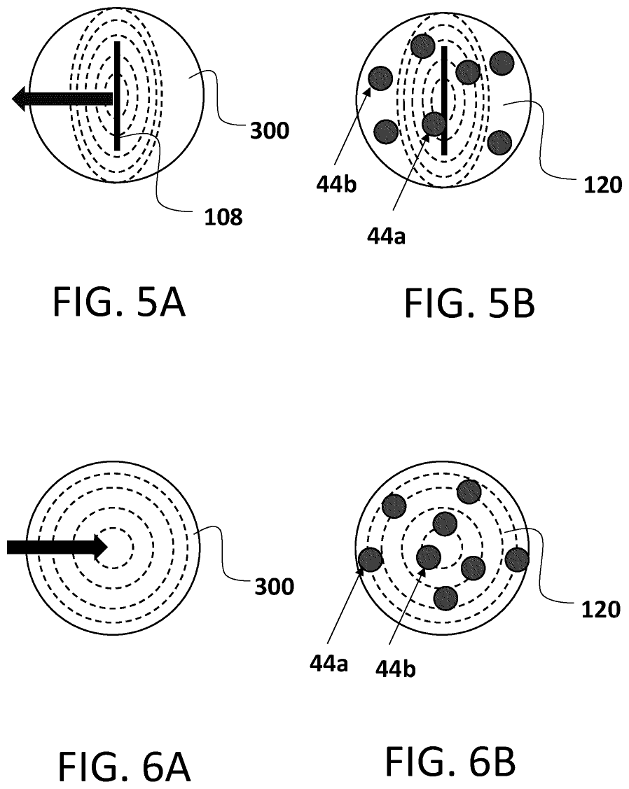

FIG. 5A shows a schematic radial cross-section depicting heat transfer within a first embodiment of the substrate of an aerosol-generating article in an aerosol-generating device with an internal heater blade;

FIG. 5B shows a schematic radial cross-sectional view of the first embodiment of the substrate of an aerosol-generating article in an aerosol-generating device with an internal heater blade;

FIG. 6A shows a schematic radial cross-section depicting heat transfer within a first embodiment of the substrate of an aerosol-generating article in an aerosol-generating device with an external heating system;

FIG. 6B shows a schematic radial cross-sectional view of the first embodiment of the substrate of an aerosol-generating article in an aerosol-generating device with an external heating system.

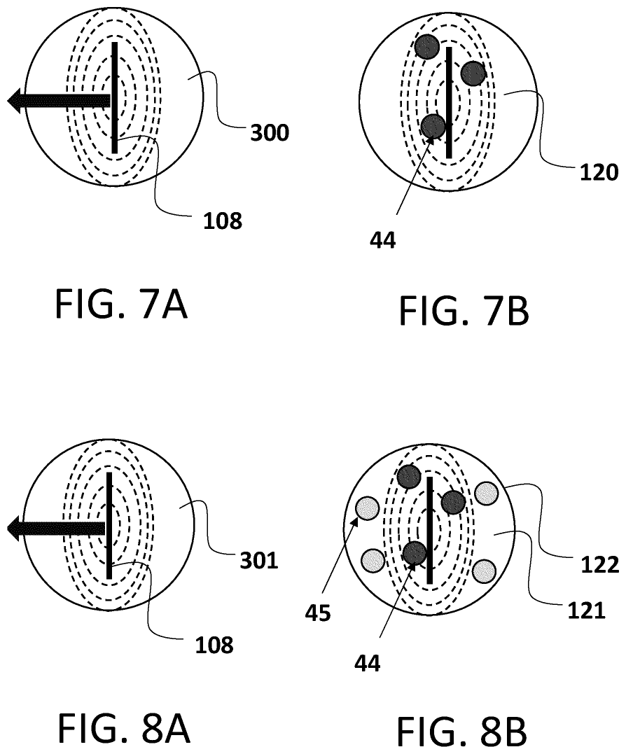

FIG. 7A shows a schematic radial cross-section depicting heat transfer within a first embodiment of the substrate of an aerosol-generating article in an aerosol-generating device with an internal heater blade;

FIG. 7B shows a schematic radial cross-sectional view of the first embodiment of the substrate of an aerosol-generating article in an aerosol-generating device with an internal heater blade;

FIG. 8A shows a schematic radial cross-section depicting heat transfer within a second embodiment of the substrate of an aerosol-generating article in an aerosol-generating device with an internal heater blade;

FIG. 8B shows a schematic radial cross-sectional view of the second embodiment of the substrate of an aerosol-generating article in an aerosol-generating device with an internal heater blade.

FIG. 1 shows a schematic view of an aerosol-generating substrate in accordance with the invention, with a magnified view of an aerosol-generating granule in inset. FIG. 1 shows an aerosol-generating substrate 300 for use in a heated aerosol-generating article, the aerosol-generating substrate 300 comprising a rod 12 of a first aerosol-generating material 120. Here the rod 12 of first aerosol-generating material 120 comprises tobacco cut filler. There is a plurality of aerosol-generating granules 44 dispersed through the rod 12 of the first aerosol-generating material 120. The plurality of aerosol-generating granules 44 comprise a porous carrier medium 441 defining a plurality of pores 442 and a second aerosol-generating material 440 releasably retained within the pores 442 of the porous carrier medium 441. The second aerosol-generating material 440 comprises a flavourant and an aerosol former. Here the porous carrier medium is vesicular basalt. The second aerosol-generating material is a liquid. The second aerosol-generating material comprises menthol and glycerine.

FIG. 2 shows a schematic cross-sectional view of a first embodiment of an aerosol-generating article 10. The aerosol-generating article 10 comprises an aerosol-generating substrate 300 comprising a rod 12 of first aerosol-generating material 120 and a downstream section 14 at a location downstream of the rod 12. Further, the aerosol-generating article 10 comprises an upstream section 16 at a location upstream of the rod 12. Thus, the aerosol-generating article 10 extends from an upstream or distal end 18 to a downstream or proximal or mouth end 20. The aerosol-generating article has an overall length of about 45 millimetres.

The downstream section 14 comprises a support element 22 located immediately downstream of the rod 12, the support element 22 being in longitudinal alignment with the rod 12. In the embodiment of FIG. 2, the upstream end of the support element 22 abuts the downstream end of the rod 12. In addition, the downstream section 14 comprises an aerosol-cooling element 24 located immediately downstream of the support element 22, the aerosol-cooling element 24 being in longitudinal alignment with the rod 12 and the support element 22. In the embodiment of FIG. 2, the upstream end of the aerosol-cooling element 24 abuts the downstream end of the support element 22.

As will become apparent from the following description, the support element 22 and the aerosol-cooling element 24 together define an intermediate hollow section 50 of the aerosol-generating article 10. As a whole, the intermediate hollow section 50 does not substantially contribute to the overall RTD of the aerosol-generating article. An RTD of the intermediate hollow section 26 as a whole is substantially 0 millimetres H₂O.

The support element 22 comprises a first hollow tubular segment 26. The first hollow tubular segment 26 is provided in the form of a hollow cylindrical tube made of cellulose acetate. The first hollow tubular segment 26 defines an internal cavity 28 that extends all the way from an upstream end 30 of the first hollow tubular segment to a downstream end 32 of the first hollow tubular segment 20. The internal cavity 28 is substantially empty, and so substantially unrestricted airflow is enabled along the internal cavity 28. The first hollow tubular segment 26—and, as a consequence, the support element 22—does not substantially contribute to the overall RTD of the aerosol-generating article 10. In more detail, the RTD of the first hollow tubular segment 26 (which is essentially the RTD of the support element 22) is substantially 0 millimetres H₂O.

The first hollow tubular segment 26 has a length of about 8 millimetres, an external diameter of about 7.25 millimetres, and an internal diameter (DFTs) of about 1.9 millimetres. Thus, a thickness of a peripheral wall of the first hollow tubular segment 26 is about 2.67 millimetres.

The aerosol-cooling element 24 comprises a second hollow tubular segment 34. The second hollow tubular segment 34 is provided in the form of a hollow cylindrical tube made of cellulose acetate. The second hollow tubular segment 34 defines an internal cavity 36 that extends all the way from an upstream end 38 of the second hollow tubular segment to a downstream end 40 of the second hollow tubular segment 34. The internal cavity 36 is substantially empty, and so substantially unrestricted airflow is enabled along the internal cavity 36. The second hollow tubular segment 28—and, as a consequence, the aerosol-cooling element 24—does not substantially contribute to the overall RTD of the aerosol-generating article 10. In more detail, the RTD of the second hollow tubular segment 34 (which is essentially the RTD of the aerosol-cooling element 24) is substantially 0 millimetres H₂O. The second hollow tubular segment 34 has a length of about 8 millimetres, an external diameter of about 7.25 millimetres, and an internal diameter (D_{STS}) of about 3.25 millimetres. Thus, a thickness of a peripheral wall of the second hollow tubular segment 34 is about 2 millimetres. Thus, a ratio between the internal diameter (D_{FTS}) of the first hollow tubular segment 26 and the internal diameter (D_{STS}) of the second hollow tubular segment 34 is about 0.75.

The aerosol-generating article 10 comprises a ventilation zone 60 provided at a location along the second hollow tubular segment 34. In more detail, the ventilation zone is provided at about 2 millimetres from the upstream end of the second hollow tubular segment 34. In this embodiment, the ventilation zone 60 comprises a circumferential row of perforations through a paper wrapper 70 and a ventilation level of the aerosol-generating article 10 is about 25 percent.

In the embodiment of FIG. 2, the downstream section 14 further comprises a mouthpiece element 42 at a location downstream of the intermediate hollow section 50. In more detail, the mouthpiece element 42 is positioned immediately downstream of the aerosol-cooling element 24. As shown in the drawing of FIG. 2, an upstream end of the mouthpiece element 42 abuts the downstream end 40 of the aerosol-cooling element 24.

The mouthpiece element 42 is provided in the form of a cylindrical plug of low-density cellulose acetate.

The mouthpiece element 42 has a length of about 12 millimetres and an external diameter of about 7.25 millimetres. The RTD of the mouthpiece element 42 is about 12 millimetres H₂O. The ratio of the length of the mouthpiece element 42 to the length of the intermediate hollow section 50 is approximately 0.6.

The rod 12 of first aerosol-generating material has an external diameter of about 7.25 millimetres and a length of about 12 millimetres.

The upstream section 16 comprises an upstream element 46 located immediately upstream of the rod 12, the upstream element 46 being in longitudinal alignment with the rod 12. In the embodiment of FIG. 2, the downstream end of the upstream element 46 abuts the upstream end of the rod 12. The upstream element 46 is provided in the form of a cylindrical plug of cellulose acetate. The upstream element 46 has a length of about 5 millimetres. The RTD of the upstream element 46 is about 30 millimetres H₂O.

The upstream element 46, rod 12, support element 22, aerosol-cooling element 24, and mouthpiece element 42 are circumscribed by the paper wrapper 70.

The rod 12 comprises a first aerosol-generating material 120 with a plurality of aerosol-generating granules 44 dispersed through the rod 12. The aerosol-generating substrate 300 is as described above with respect to FIG. 1.

FIG. 3 shows a schematic longitudinal cross-sectional view of a second embodiment of an aerosol-generating substrate within an aerosol-generating article. Identical reference numerals have been used for identical components in the embodiments of FIGS. 2 and 3.

In rod 12 of aerosol-generating material 121 of substrate 301 of the second embodiment, the aerosol-generating substrate 301 comprises a plurality of first aerosol-generating granules 44 comprising a second aerosol-generating material 440 and a second plurality of aerosol-generating granules 45 comprising a third aerosol-generating material 450 having a different composition to the second aerosol-generating material 440. In the rod 12 of substrate 301, the plurality of first aerosol-generating granules 44 and the second plurality of aerosol-generating granules 45 are both evenly dispersed and randomly interspersed through the rod 12 of first aerosol-generating material.

FIG. 4 shows a schematic longitudinal cross-sectional view of an aerosol-generating system 100. The system 100 comprises an aerosol-generating device 102 and the aerosol-generating article 10 of FIG. 2.

The aerosol-generating device 102 comprises a battery 104, a controller 106, a heating blade 108 coupled to the battery, and a puff-detection mechanism (not shown). The controller 106 is coupled to the battery 104, the heating blade 108 and the puff-detection mechanism.

The aerosol-generating device 102 further comprises a housing 110 defining a substantially cylindrical cavity for receiving a portion of the article 10. The heating blade 108 is positioned centrally within the cavity and extends longitudinally from a base of the cavity. In this embodiment, the heating blade 108 comprises a substrate and an electrically resistive track located on the substrate. The battery 104 is coupled to the heating blade 108 so as to be able to pass a current through the electrically resistive track and heat the electrically resistive track and heating blade 108 to an operational temperature.

In use, a user inserts the article 10 into the cavity, causing the heating blade 108 to penetrate the upstream element 46 and rod 12 of first aerosol-generating material of aerosol-generating substrate 300 of the article 10. FIG. 3 shows the article 10 inserted into the cavity of the device 102.

Then, the user puffs on the downstream end of the article 10. This causes air to flow through an air inlet (not shown) of the device 102, then through the article 10, from the upstream end 18 to the downstream end 20, and into the mouth of the user.

The user puffing on the article 10 causes air to flow through the air inlet of the device. The puff-detection mechanism detects that the air flow rate through the air inlet has increased to greater than a non-zero threshold flow rate. The puff-detection mechanism sends a signal to the controller 106 accordingly. The controller 106 then controls the battery 104 so as to pass a current through the electrically resistive track and heat up the heating blade 108. This heats up the rod 12, which is in contact with the heating blade 108.

Heating of the aerosol-generating substrate cause the aerosol-generating substrate to release volatile compounds. These compounds are entrained by the air flowing from the upstream end 18 of the article 10 towards the downstream end 20 of the article 10. The compounds cool and condense to form an aerosol as they pass through the internal cavities 28, 36 of the support element and the aerosol-cooling element. The aerosol then passes through the mouthpiece element 42, which may filter out unwanted particles entrained in the air flow, and into the mouth of the user.

When the user stops inhaling on the article 10, the air flow rate through the air inlet of the device decreases to less than the non-zero threshold flow rate. This is detected by the puff-detection mechanism. The puff-detection mechanism sends a signal to the controller 106 accordingly. The controller 106 then controls the battery 104 so as to reduce the current being passed through the electrically resistive track to zero.

After a number of puffs on the article 10, the user may choose to replace the article 10 with a fresh article.

FIG. 5A shows a schematic radial cross-section depicting heat transfer within the substrate 300 of an aerosol-generating article in an aerosol-generating device with an internal heater blade 108. Heat is transferred as indicated by the dashed ellipses in the direction of the bold arrow, outward from the heater blade 108, in order to heat substrate 300. Heat therefore reaches the core of the aerosol-generating substrate 300 before its periphery.

FIG. 5B shows the same schematic radial cross-sectional view of the substrate 300 as FIG. 5A, but also shows a plurality of aerosol-generating granules 44. As depicted, aerosol-generating granule 44a is closer to heater blade 108 than aerosol-generating granule 44b. Because of its proximity to the heater blade 108, aerosol-generating granule 44a will be heated earlier than aerosol-generating granule 44b. As aerosol-generating granule 44a will be heated to an aerosolization temperature prior to aerosol-generating granule 44b, second aerosol-generating material 440a will volatilise from aerosol-generating granule 44a prior to second aerosol-generating material 440b volatilising from aerosol-generating granule 44b. In the embodiment shown in FIG. 5B, second aerosol-generating material 440a, 440b releasably retained within aerosol-generating granules 44a, 44b has a lower aerosolization temperature than surrounding first aerosol-generating material 120, and therefore second aerosol-generating material 440a, 440b volatilises earlier than first aerosol-generating material 120.

FIG. 6A shows a schematic radial cross-section depicting heat transfer within the substrate of an aerosol-generating article in an aerosol-generating device with an external heating system. Heat is transferred as indicated by the dashed circles in the direction of the bold arrow, inward from the external heating system (not shown), in order to heat substrate 300. Heat therefore reaches the periphery of the aerosol-generating substrate 300 before its core.

FIG. 6B shows the same schematic radial cross-sectional view of the substrate 300 as FIG. 6A, but also shows a plurality of aerosol-generating granules. As depicted, aerosol-generating granule 44a is closer to the external heating system than aerosol-generating granule 44b. Because of its proximity to the external heating system, aerosol-generating granule 44a will be heated earlier than aerosol-generating granule 44b. As aerosol-generating granule 44a will be heated to an aerosolization temperature prior to aerosol-generating granule 44b, second aerosol-generating material 440a will volatilise from aerosol-generating granule 44a prior to second aerosol-generating material 440b volatilising from granule 44b.

FIG. 7A shows a schematic radial cross-section depicting heat transfer within the substrate 300 of an aerosol-generating article in an aerosol-generating device with an internal heater blade 108. FIG. 7A is otherwise identical to FIG. 5A.

FIG. 7B shows the same schematic radial cross-sectional view of the substrate 300 as FIG. 7A, but also shows a plurality of aerosol-generating granules 44. In the rod 12 of substrate 300, the plurality of aerosol-generating granules 44 is unevenly dispersed through the rod 12 of first aerosol-generating material 120, with the plurality of aerosol-generating granules 44 being aggregated in an area of the substrate in proximity to heating element 108 and absent in areas of the substrate that are more distant from the heating element and closer to the outer surface of the rod 12.

FIG. 8A shows a schematic radial cross-section depicting heat transfer within the substrate 301 of an aerosol-generating article in an aerosol-generating device with an internal heater blade 108. FIG. 8A is otherwise identical to FIG. 5A.

FIG. 8B shows the same schematic radial cross-sectional view of the substrate 301 as FIG. 8A, but also shows a plurality of first aerosol-generating granules 44 and a plurality of second aerosol-generating granules 45. The plurality of first aerosol-generating granules 44 comprises a second aerosol-generating material 440 and the plurality of second aerosol-generating granules 45 comprises a third aerosol-generating material 450 having a different composition to the second aerosol-generating material 440. In the rod 12 of first aerosol-generating material 121 of substrate 301, the plurality of first aerosol-generating granules 44 and the plurality of second aerosol-generating granules 45 are both unevenly dispersed through the rod 12 of first aerosol-generating material 120, with the plurality of first aerosol-generating granules 44 being aggregated in an area of the substrate in proximity to heating element 108 and absent in areas of the substrate that are distant from the heating element and closer to the outer surface 122 of the rod 12. Within the same substrate, the plurality of second granules 45 is aggregated in areas of the substrate that are distant from a heating element 108 and closer to the outer surface 122 of the rod 12, while the plurality of second granules is absent in areas of the substrate that are in proximity to the heating element 108.

1.-15. (canceled)

16. An aerosol-generating substrate for a heated aerosol-generating article, the aerosol-generating substrate comprising:
a rod of a first aerosol-generating material, wherein the first aerosol-generating material comprises tobacco cut filler, or wherein the first aerosol-generating material comprises one or more sheets or strands of homogenised plant material; and
a plurality of aerosol-generating granules dispersed through the rod of the first aerosol-generating material, wherein the plurality of aerosol-generating granules comprise a porous carrier medium defining a plurality of pores and a second aerosol-generating material releasably retained within the pores of the porous carrier medium, the second aerosol-generating material being in the form of a liquid or a gel and comprising a flavourant and an aerosol former.

17. The aerosol-generating substrate according to claim 16, wherein the porous carrier medium comprises one or more of a ceramic, an igneous rock, and a sedimentary rock.

18. The aerosol-generating substrate according to claim 16, wherein the porous carrier medium comprises one or more of basalt, pumice, scoria, expanded clay, limestone, and sandstone.

19. The aerosol-generating substrate according to claim 16, wherein the porosity of the porous carrier medium is between 30 percent and 70 percent.

20. The aerosol-generating substrate according to claim 16, wherein the plurality of aerosol-generating granules have a median particle size of between 0.1 millimetre and 3 millimetres.

21. The aerosol-generating substrate according to claim 16, wherein the plurality of aerosol-generating granules have a pore size of between 1 micrometre and 100 micrometres.

22. The aerosol-generating substrate according to claim 16, wherein the second aerosol-generating material has a lower aerosolization temperature than the first aerosol-generating material.

23. The aerosol-generating substrate according to claim 16, wherein the plurality of aerosol-generating granules have a specific surface area of between 1 square metre per gram and 800 square metres per gram.

24. The aerosol-generating substrate according to claim 16, wherein the second aerosol-generating material is a gel aerosol-generating material comprising at least one gelling agent.

25. The aerosol-generating substrate according to claim 16, wherein a ratio of a total envelope volume of the plurality of aerosol-generating granules to a total volume of the aerosol-generating substrate is between 0.05 and 0.5.

26. The aerosol-generating substrate according to claim 16, wherein the plurality of aerosol-generating granules are substantially uniformly distributed throughout the rod of the first aerosol-generating material.

27. The aerosol-generating substrate according to claim 16, further comprising:
a plurality of first aerosol-generating granules comprising a first porous carrier medium defining a plurality of pores and a second aerosol-generating material releasably retained within the pores of the first porous carrier medium; and
a plurality of second aerosol-generating granules comprising a second porous carrier medium defining a plurality of pores and a third aerosol-generating material releasably retained within the pores of the second porous carrier medium,
wherein the third aerosol-generating material is a liquid or a gel,
wherein the plurality of first aerosol-generating granules and the plurality of second aerosol-generating granules are dispersed through the rod of the first aerosol generating material, and
wherein the first aerosol-generating granules are different from the second aerosol-generating granules.

28. An aerosol-generating article comprising the aerosol-generating substrate according to claim 16.

29. The aerosol-generating article according to claim 28, further comprising a downstream section downstream of the aerosol-generating substrate, the downstream section comprising at least one hollow tubular element.

30. An aerosol-generating system comprising the aerosol-generating article according to claim 28 and an electrical aerosol-generating device configured to heat the aerosol-generating substrate of the aerosol-generating article.
